(19) United States
(12) Patent Application Publication
(10) Pub. No.: US 2016/0086261 A1
(43) Pub. Date: Mar. 24, 2016

(54) METHOD AND SYSTEM FOR PROVIDING JUST IN TIME ACCESS TO EARNED BUT UNPAID INCOME AND PAYMENT SERVICES

(71) Applicant: PAYACTIV Inc., San Jose, CA (US)

(72) Inventors: Safwan Shah, Saratoga, CA (US); Sohail Aslam, Milpitas, CA (US); Ijaz Anwar, San Jose, CA (US)

(73) Assignee: PAYACTIV, INC., San Jose, CA (US)

(21) Appl. No.: 14/849,851

(22) Filed: Sep. 10, 2015

Related U.S. Application Data
(60) Provisional application No. 62/053,658, filed on Sep. 22, 2014.

(51) Int. Cl. G06Q 40/02; G06Q 20/18; G06Q 20/32; G06Q 10/10

(52) U.S. Cl. CPC G06Q 40/025; G06Q 10/105; G06Q 20/18; G06Q 20/3223

(57) ABSTRACT

Methods and systems (including associated devices) are disclosed herein that allow for the providing of one or more financial services, including the facilitating of access to accrued but unpaid earnings, to users such as employees of employers. In at least some embodiments, the extent to which services can be accessed or used is determined at least in part based upon one or more risk determinations. For example, in the case of a service for distributing accrued but unpaid earnings before an end of a pay period to an employee (sometimes in the absence of immediate access to a number of hours the employee has worked), risk factors such as a number of future repayments promised as well as a currency multiple can be used to adjust a risk score. Also, in at least some embodiments, access by an employee to an account is performed via a kiosk and allowed only if a code provided to an employee mobile device is entered at the kiosk.

### CROSS-REFERENCES TO RELATED APPLICATIONS

This application claims the benefit of U.S. Provisional Application No. 62/053,658 filed 22 Sep., 2014.

### FIELD

The present disclosure relates generally to systems and methods for performing financial data processing and/or conducting financial transactions.

### BACKGROUND

According to the Federal Deposit Insurance Commission, over 80 million individuals in the United States are financially underserved. Up to 75% of the working population survives paycheck to paycheck with little to no savings. Credit is generally restricted, but for the underserved, credit is either non-existent or very expensive. The current banking system is generally not equipped to serve low to moderate income consumers, leaving them without many viable choices when making financial adjustments in the absence of credit and savings. Therefore, the underserved population accesses over $790 billion in alternative financial services (AFS) such as bill pay, check cashing, and remittance from non-bank sources. Fees for AFS cost the underserved about $89 billion annually. In addition, another $100 billion is accessed as payday loans annually. A typical payday loan is $400 with an APR in the range of 600%.

The underserved population continues to grow year after year due to financial regulations and macroeconomic conditions. The latest figures reveal that 40% of households earning less than $50 k are underserved, and additionally that even 19% of households earning between $50 k and $75 k and 14% of households earning over $75 k are also underserved. According to publically available research, within the U.S., the underserved collectively represent $1 trillion in annual spending with less than 10% market penetration. Global trends of the underserved, when compared to the U.S., represent an opportunity of a much larger magnitude.

### SUMMARY

Generally, the present disclosure relates to methods and systems for providing one or more financial services including (but not limited to) facilitating the accessing of accrued but unpaid earnings. In at least some embodiments, the present disclosure pertains to a financial transactions system involving interactions between one or more third party computer system(s) of or associated with a third party, one or more employer computer system(s), one or more employee computer system(s), and/or one or more other user access system(s). In at least some such embodiments, operation of the financial transactions system includes pre-enrollment interactions between employers and the third party (via their respective computer systems), enrollment operations between employees and third party (via appropriate ones of the computer system(s) or other user access system(s) such as kiosks), and service access/use operations between the employees and third party (also via appropriate ones of the computer system(s) or other user access system(s) such as kiosks). Additionally, in at least some embodiments encompassed herein, the service access/use operations are ones by which an employee interacts with the third party (again via appropriate ones of the computer system(s) or other user access system(s) such as kiosks) to access accrued but unpaid earnings.

Further, in at least some embodiments, the present disclosure particularly relates to a system for making payments to employees based on accrued but unpaid earnings before an end of a pay period, where risk factors are taken into account to determine whether payments can be accessed and, if so, the amounts of the payments that can be made. Besides estimating risk based on the current date with respect to a pay period and an hourly rate or salary of an employee, risk can be estimated based upon any of a variety of other factors including, for example, the currency multiple dispensed at a kiosk (e.g., $20 bills, $50 bills) and a number of promised repayments (e.g., 2 repayments, 5 repayments). Also, a fixed fee can be charged for each repayment, and the fee can be adjusted based on risk.

Additionally, in at least some embodiments, the present disclosure particularly relates to a method of facilitating payment to employees of accrued and unpaid earnings before an end of a current pay period. The method can include receiving a request from an employee for payment, estimating a current accrued and unpaid earnings for the employee, the estimating based upon an hourly rate of the employee, the estimating occurring without access to actual hours that the employee has worked, calculating a risk of repayment based on the estimating, transferring money to the employee based on the risk being within a threshold, determining a number of repayments, and deducting a fixed fee for each of the repayments. Further, in at least some additional embodiments, an employee attempts to access the current accrued and unpaid earnings by way of a kiosk. In some such embodiments, the employee is only allowed to make use of the service if the employee also has a mobile device with a telephone number that was previously registered with the system so that, upon attempting to make use of the service, the employee is able to receive (by way of the employee's mobile device) a code that is transmitted to the mobile device at that time, such that the employee is then able to enter the code at the kiosk.

Also, in at least some embodiments, the present disclosure relates to a system for determining risk of default from payments to employees of accrued and unpaid earnings before an end of a current pay period. The system includes a computer processor and a memory operatively coupled with the computer processor, and the computer processor executes operations from the memory. A payment distribution device is operatively connected with the computer processor, an input device is configured to receive a request for payment of accrued and unpaid earnings from an employee of an employer, a risk analysis engine is configured to determine a risk of nonpayment by an employee, the determination based on a current date, an hourly rate or salary of the employee, a currency multiple dispensed at a kiosk, and a number of repayments promised. The computer processor can command the payment distribution device based on the risk determined by the risk analysis engine.

### BRIEF DESCRIPTION OF THE DRAWINGS

FIG. 1 is a schematic diagram illustrating an overall financial transactions system by which employers and employees can interact with a third party providing one or more services generally referred to herein as a Cash Access Network (CAN), in accordance with one embodiment of the present disclosure;

FIG. 2 is a schematic diagram of components illustrating example components of one of the system components of FIG. 1;

FIG. 3 is a flowchart illustrating steps of an example process involving interaction and operation of the system components of the financial transactions system of FIG. 1, in accordance with one embodiment of the present disclosure;

FIG. 4 is a flowchart illustrating steps of an example employee pre-enrollment subprocess that is encompassed by the process of FIG. 3;

FIG. 5 is a flowchart illustrating steps of an example employee enrollment subprocess that is encompassed by the process of FIG. 3;

FIG. 6 is a flowchart illustrating steps of an example time management data importation subprocess that is encompassed by the process of FIG. 3;

FIG. 7 is a flowchart illustrating steps of an example subprocess in accordance with which an employee is able to access a portal provided by way of a third party computer system as shown in FIG. 1, where that subprocess is encompassed by the process of FIG. 3;

FIG. 8 is a flowchart illustrating steps of a further example subprocess that can be considered to form or be related to the subprocess of FIG. 7, in accordance with which an employee is able to utilize a shopping cart for financial services made accessible by way of the third party computer system of FIG. 7;

FIG. 9 is a flowchart illustrating steps of a further example subprocess that can be considered to form or be related to the subprocess of FIG. 7, in accordance with which rules are applied by a rules engine of the third party computer system of FIG. 1; and

FIG. 10 shows example screen shots of an example user interface provided by a mobile device when accessing the portal in accordance with the subprocess of FIG. 7.

### DETAILED DESCRIPTION

The present disclosure relates to methods and systems for performing financial transactions and in at least some embodiments relates to such methods and systems that involve the establishment and operation of a financial services network, referred to as a “Cash Access Network” (or “CAN”), by way of an intermediary or “third party” that interacts with employers and their employees. In at least some such embodiments, members of the CAN (particularly employee members of the CAN) are able to instantly access wage advances and other financial services such as check cashing, bill pay, remittance, savings, prepaid long distance minutes, prepaid cellular top-up, open and closed loop prepaid cards, payroll cards, secured and unsecured credit cards, budgeting tools, credit counseling, auto financing, and other relevant products, services, offers and discounts. Further, in at least some embodiments, the CAN is designed to offer its members (particularly employee members) products and services based on the employee's employment status and income. Additionally, in least some embodiments, employment is generally a pre-requisite to access the membership program, and the membership program is offered by the third party to employees by way of their employers (that is, it is by virtue of the employer's participation in the CAN that the CAN in turn becomes accessible and usable by the employer's employees). Also, in at least some such embodiments, the third party acts as a benefit administrator and a payment processor between the employer and the employee.

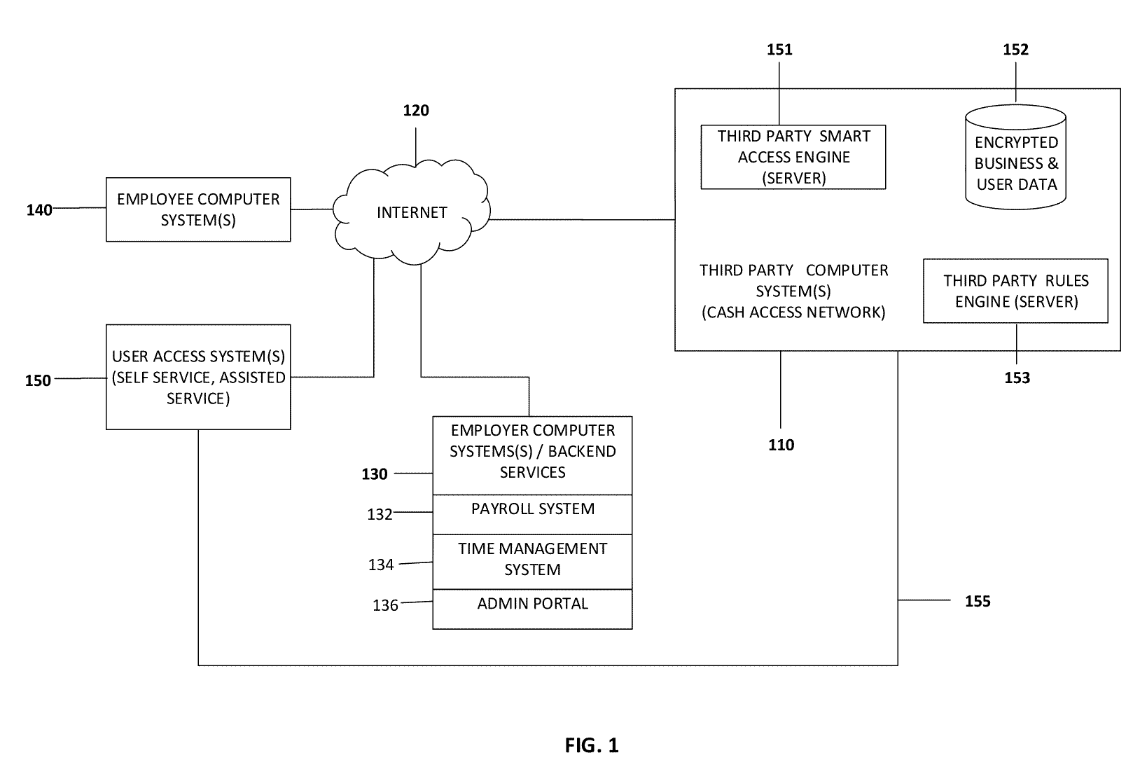

Referring to FIG. 1, a schematic diagram shows an overall financial transactions system 100 by which employers and employees can interact directly or indirectly with a third party so as to access or utilize one or more services generally offered by the CAN. In the present embodiment, the system 100 particularly allows for access to financial services at the place of employment without using a bank account or tapping into savings or credit cards. As shown, the system 100 particularly includes one or more third party (CAN provider) computer system(s) 110 that is or can be in communication by way of one or more networks and/or communication links, represented generally by way of communication networks 120, with one or more employer computer system(s) 130, one or more employee computer system(s) 140, and one or more other user access system(s) 150 (the user access system(s) 150 can be considered “other” user access system(s) insofar as the employer and/or employee computer system(s) 130 and 140 can also be considered user access system(s)). In the present embodiment, the system(s) 110, 130, 140, and 150 can be understood to interact generally in accordance with a client-server model of operation, with the third party computer system(s) 110 serving as the server (or servers) and the employer computer(s) systems 130, employee computer system(s) 140, and other user access system(s) 150 operating as clients in relation to that server (or servers).

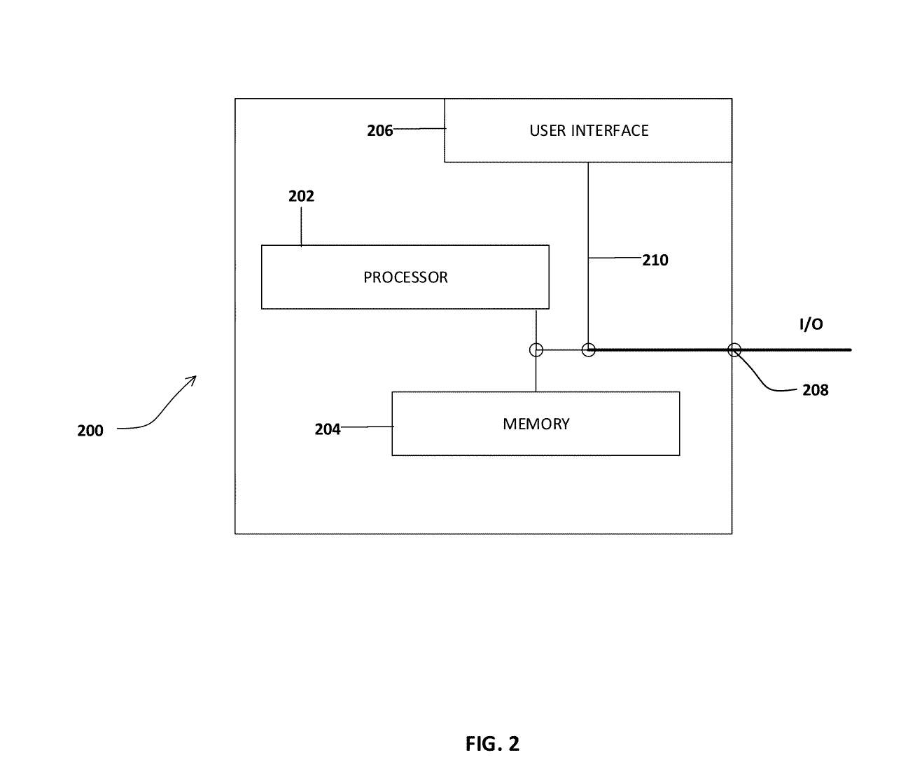

Although shown in a simplified manner, it should be appreciated that the financial transactions system 100 is intended to be representative of a wide variety of particular embodiments employing any of a variety of different interacting systems. To begin, the third party computer system 110, although shown as a single computer system, can nevertheless depending upon the embodiment involve any of one or more than one computer systems that are owned and operated by, or controlled by, or affiliated with, a third party (e.g., a third party corporation or other entity) that is offering or managing the CAN. In this regard, FIG. 2 provides a schematic diagram illustrates an example computer system 200 as having a processor 202, a memory 204, a user interface 206, and an input/output port 208 that are all in communication (directly or indirectly) via one or more internal communication links 210 (e.g., a communication bus) within the computer system 200.

It should be appreciated that any of the one or more third party computer system(s) 110 can take the form of the computer system 200. Additionally, it should be appreciated that the processor 202 depending upon the embodiment can take any of a variety of system forms that perform the execution of software code, perform processing or tasks, operate in accordance with instructions, or otherwise serve a processing purpose. For example, in at least some embodiments, the processor 202 can take the form of a microprocessor, the form of one or more other processing devices such as programmable logic devices, or can take the form of multiple processing devices interacting with one another. In general, the present disclosure is intended to encompass a variety of embodiments of processing systems and devices including processing systems and devices employing hardware, software, firmware, middleware, microcode, hardware description languages, or any combination thereof.

Also, the memory 204 depending upon the embodiment can take any of a variety of forms including, for example, a database, and also can take the form of multiple memory devices interacting with one another. Indeed, the memory can encompass any one or more devices for storing, containing, or carrying information, instructions, or data, including read-only memory (ROM), random access memory (RAM), magnetic RAM, core memory, magnetic disk storage media, optical storage media, flash memory devices, or other computer-readable media (e.g., portable or fixed storage devices, optical storage devices, wireless channels, a sim card, other smart cards, and various other media) capable of storing, containing, or carrying information, instructions, or data. When implemented in software, firmware, middleware, or microcode, program code or code segments employed to perform the processing or tasks can be stored in such memory or computer-readable media.

Further, the user interface 206 can take any of a variety of forms including, for example, a keyboard, a monitor, a mouse or pointing device, and/or a touch screen and also can take the form of multiple user interface devices interacting with one another and/or the other components of the computer system 200. Also in at least some embodiments, the user interface 206 can include one or more sensors including, for example, image or light sensors (e.g., camera devices), position sensors, orientation sensors, accelerometers, etc. Also, the input/output port 208 is intended to be representative of any of a variety of input and/or output terminals that allow for communication between the computer system 200 and other systems or devices including, for example, one or more other computer systems encompassed by the computer system(s) 110, and/or any one or more of the employer computer system(s) 130, employee computer system(s) 140, and/or other user access system(s). The one or more input and/or output terminals encompassed by the input/output port 208 further is or are configured to allows for such communications to occur by way of any of a variety of communications media including, for example, wired or wireless communication links and any of a variety of networks or other communication links such as the network(s) 120. In this regard, it should particularly be appreciated that the communication network(s) 120 in at least some embodiments include the internet.

It should additionally be appreciated that the computer system 200 can be implemented in any of a number of forms including, for example, a server computer, a personal computer, a mainframe computer, or even a mobile device (e.g., a computer system taking the form of a cellular telephone, a handheld device, a personal digital assistant (PDA), etc.). Although in some embodiments the computer system 200 and particularly the processor 202 and memory 204 thereof is a proprietary computer system owned and operated by the third party (e.g., a computer server owned and operated by the third party), in other embodiments the processor 202 and/or memory 204 are provided by the third party by utilizing still another party's processing and/or memory resources in a manner partly, substantially, or entirely controlled by the third party, for example, by utilizing cloud computer services, particularly cloud computer services that provide a secure storage mechanism for data (e.g., so that the data is exclusively accessible by the third party/third party computer system(s) 110).

Additionally, although the computer system 200 is intended to be representative of one of the third party computer systems 110 of FIG. 1 in particular, it should also be understood that any of the employer computer system(s) 130, employee computer systems 140, and other user access system(s) 150 can also take any of the forms described above or represented by the computer system 200. In particular, as discussed further below, in at least some embodiments, the overall financial transactions system 100 is configured to allow for employees to interact with the system by way of mobile device(s) or desktop (or laptop) computers (e.g., web solution-equipped computers or computerized devices) of the employees, which can serve as the employee computer system(s) 140. The other user access system(s) 150 can also take any of a variety of forms including, for example, kiosks, which in some embodiments are located at the facilities of the employers at which the employees work and/or at other suitable or convenient locations or, further for example, retail point-of-sale (POS) systems, which in some embodiments are located at stores or retail outlets or at other suitable or convenient locations. In some embodiments, the user access system(s) 150 are merely systems that allow for accessing or communicating with the third party computer system(s) 110. Also, depending upon the embodiment, the user access system(s) 150 can be self-service system(s) (e.g., that are operated or controlled by users in a self-service manner) or can be assisted service system(s) (e.g., where assistance can be provided from another source, such as from the third party).

It should also be appreciated that, although in some embodiments the user access system(s) 150 are not only computer systems that are distinct from the third party computer system(s) 110 (as well as distinct from the employer computer system(s) 130 and employee computer system(s) 140) and are owned and operated by parties other than the third parties owning and operating the third party computer system(s), in other embodiments one or more of the user access system(s) 150 are owned by the same third parties that own and operate the third party computer system(s). For example, a kiosk constituting one of the user access system(s) 150 can be owned and operated by one of the third parties owning and operating one or more of the third party computer system(s). In some such embodiments, accordingly, one or more of the user access system(s) 150 can be in communication with one or more of the third party computer system(s) 110 by way of communication linkages other than the networks 120, e.g., by way of proprietary networks or linkages that are intended to be represented by a linkage 155 shown in FIG. 1. Although in the present embodiment the overall financial transactions system 100 is one in which operations are generally conducted in accordance with the client-server model (again, with the third party computer system(s) 110 generally operating as server computer(s) and the other systems 130, 140, and 150 generally operating as clients), this need not be the case in other embodiments.

In the present embodiment, the overall financial transactions system 100 and particularly the third party computer system(s) 110 are configured to perform any of several different related (or connected) operations or services so as to achieve the CAN, which is intended in the present embodiment to be a comprehensive financial services solution. FIG. 1 particularly illustrates, in relation to the employer computer system(s) 130, that one or more of these systems are particularly intended to provide or serve as a payroll system 132, a time management system 134, and an administrative portal 136, in accordance with at least one embodiment described herein. Also, in at least some embodiments, the employer computer system(s) 130 can provide services such as backend services. Further, in accordance with at least one embodiment herein, the third party computer system(s) include, as shown in FIG. 1, a first subsystem 151 (or portion of the system(s) that performs one or more processes or subprocesses) constituting a third party smart access engine, as well as a second subsystem 153 (or portion of the system(s) that performs one or more processes or subprocesses) constituting a third party rules engine, and each of the first and second subsystems 151 and 153 can in turn be in communication with and/or access an encrypted business and user data memory subsystem 152 associated with (or otherwise accessible to) the third party computer system(s) 110. Additionally, in at least some such embodiments, the first subsystem 151 is (or includes) a first additional server computer and the second subsystem 153 is (or includes) a second additional server computer that are among the third party computer system(s) 110 that serve as the CAN provider. Through the use of such subsystems and data/information or otherwise, in at least some embodiments, the functions that can be performed or undertaken by the third party computer system(s) 110 on behalf of one or more third parties in the present embodiment include each of the following:
Underwriting of risk related to the employer and employee for services offered under the CAN.
Transaction processing (e.g., the third party computer system(s) 110 can serve as a transaction processor for performing processing) that includes one or more of the following functions:
   Employer Enrollment;
   Employee Pre-Enrollment & Enrollment;
   Transaction Authorization;
   Kiosk Based Fulfillment (cash, billpay, remittances, check cashing, other);
   Settlement, for example by way of any of Automatic Clearing House (ACH), prepaid card/debit card, eWallet, retail point-of-sale (POS), and/or other systems or mechanisms;
   Repayment/Collection (payroll deductions or paid directly to the third party through cash, ACH, credit, debit, check, wire transfer, other);
   Operation of the CAN so as to provide additional products and services such as Wage Advances, Billpay, Remittance, Check Cashing, Savings, Loyalty, Prepaid LD (e.g., long distance) minutes & Cellular Top-Up, Credit Counseling, Credit Reporting, Budgets, Prepaid Cards, Secured & Unsecured Credit Cards, eWallets, Offers & Discounts for good & services and other financial services;
   Peer to Peer lending platform for CAN members; and/or
   Bilingual Customer Service supporting all of the above functions.

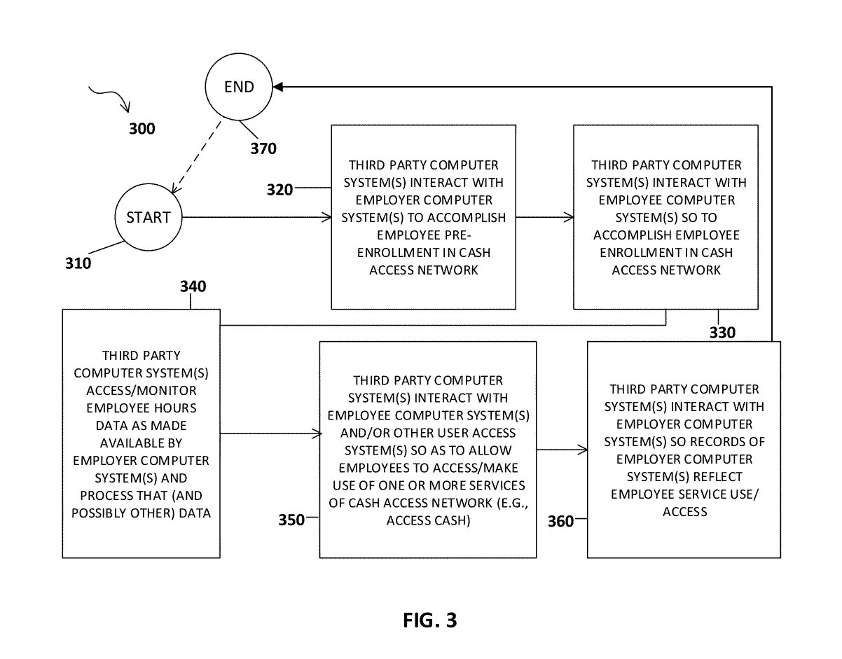

Turning to FIG. 3, a flowchart 300 shows a general process of operation of the overall financial transactions system 100 of FIG. 1. Although the operation of the financial transactions system 100 involves a variety of interactions among and suboperations performed by the third party computer system(s) 110, employer computer system(s) 130, employee computer system(s) 140, and other user access system(s) 150 (including interactions via the networks 120), for simplicity the flowchart 300 is shown to include steps that reflect the overall process of operation as viewed from the standpoint of the third party and involve the third party computer system(s) in particular. Nevertheless, it should be appreciated that the overall process of operation of the overall financial transactions system 100, or at least portions of that process, can also be viewed from the standpoint of the employer computer system(s) 130, employee computer system(s) 140, and/or other user access system(s) 150, and can also include suboperations that are performed entirely or substantially entirely by those system 130, 140, and 150.

As shown, the process represented by the flowchart 300 commences at a start step 310 and then proceeds to a step 320, at which the third party computer system(s) 110 interact with the employer computer system(s) 130 to accomplish employee pre-enrollment in the CAN (Cash Access Network). Next the process advances to a step 330, at which the third party computer system(s) 110 interact with the employee computer system(s) 140 so as to accomplish employee enrollment in the CAN. Further, at a step 340 following the step 330, the third party computer system(s) 110 access/monitor employee hours data (and possibly other employee data) as made available by the employer computer system(s) 130, and perform processing in relation to that (and possibly other) data. Subsequently, at a step 350, the third party computer system(s) 110 interact with the employee computer system(s) 140 and/or the other user access system(s) 150 so as to allow employees to access or make use of one or more of the services of the CAN including, for example, the service of obtaining a cash advance based upon income that has already been earned by the employees but not yet paid by the employers to the employees and/or also possibly reflective of certain as-of-yet unearned income. Further, at a step 360, the third party computer system(s) 110 additionally interact with the employer computer system(s) 130 so that the records of the employer computer system(s) properly reflect the employee service access or use, and/or the results of that access or use. For example, to the extent that an employee accessed cash via the CAN, then employer computer system(s) 130 can be notified or updated to reflect that occurrence. Finally, the flowchart 300 is shown to be completed at an end step 370.

Although the process represented by the flowchart 300 is illustrated as being a sequential process, it should be appreciated that the process and particularly the steps 320, 330, 340, 350, and 360 can be repeated and also be performed in a different order and/or simultaneously with one another depending upon the embodiment or circumstance. For example, it will be appreciated that the steps 320 and 330 can be repeatedly performed to accommodate changes in the employees of a given employer, and to allow for continuous or substantially ongoing enrollment of new employees over time. Also, the step 340 and can be repeated on an ongoing basis, e.g., on a monthly basis, so that the employee hours data or other employee data reflects the most recent performance of employees and so that the earned income (and particularly the earned but not yet paid income) can be determined. Likewise, the step 350 can be performed repeatedly in relation to different ones of the employee computer system(s) 140 and other user access system(s) 150 on behalf of different employees or different times at which the same employees attempt to the same or different ones of the services offered by the CAN and the step 360 can be performed repeatedly as such service access or use events occur. Also, as represented by a dashed arrow linking the end step 370 with the start step 310, the overall process can be performed on multiple occasions over and over again.

Employee Pre-Enrollment

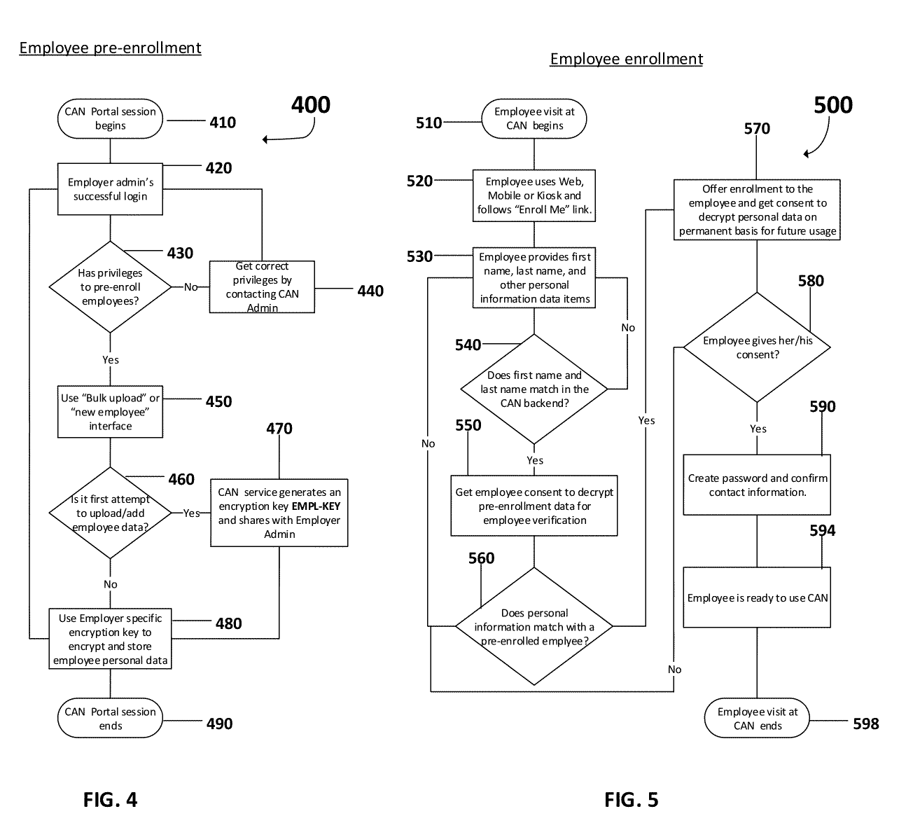

Turning next to FIG. 4, a flow chart 400 shows example steps (or substeps) of a subprocess corresponding to the step 320 of FIG. 3, during which an example one of the third party computer systems 110 interact with an example one of the employer computer systems 130 to accomplish employee pre-enrollment in the CAN. As already mentioned, in the present embodiment the interactions between are achieved by way of a client-server model of interaction in which the employer computer system accesses a website or portal provided by the third party computer system 130, downloads web pages from that website, and receives from and provides to that website various information. Accordingly, the subprocess of FIG. 4 begins at a step 410, at which a portal session begins. Generally speaking, in order for a portal session to be conducted between the employer computer system 130 and the third party computer system 110, the employer gets a secured account and access to the third party's online portal. Assuming that such account setup has been performed, at a next step 420, the employer computer system 130 as operated by an administrator employed by or otherwise associated with the employer associated with that employer computer system successfully logs in to the portal so as to establish the portal session.

Next, at a step 430, the third party computer system 110 determines whether the employer computer system 130 that has logged in has privileges to pre-enroll employees on behalf of the employer associated with employer computer system. If not, then the subprocess advances to a step 440, at which further communications are performed between the third party computer system 110 and employer computer system 130 by which the employer associated with that employer computer system is ascribed such privileges from the CAN administrator, and additionally the subprocess then returns to the step 420. Alternatively, if at the step 430 the third party computer system determines that the employer computer system 130 does have privileges to pre-enroll employees of the employer associated with that employer computer system, then the process advances to a step 450 at which employee information is uploaded from the employer computer system to the third party computer system 110. In at least some embodiments or circumstances, the website of the third party computer system 110 provides web pages that allow for one or both of a “bulk upload” interface or a “new employee” interface to be utilized for the uploading of employee information.

In the present embodiment the third party computer system 110 of the third party utilizes a data encryption process to enroll employees into the program, and this mechanism generally disallows personal identifiable employee data to be viewed or retained by the third party without employee consent. Accordingly, next at a step 460, the third party computer system 110 determines whether the attempt at uploading employee information at the just-performed step 450 was the first attempt at uploading/adding that employee data. If it was the first attempt, then the process advances to a step 470, at which the third party computer system 110 enabling the CAN service generates an encryption code or key (“EMPL-KEY”) that is specific for the employer associated with the employer computer system 130, and provides that key to the employer computer system 130 for receipt and use by the employer administrator. Further, once the encryption key has been assigned and sent to the employer computer system 130, then additionally at a step 480 that employer specific encryption key is used to encrypt and store the employee personal data that was uploaded at the step 450. Alternatively, the attempt at uploading employee information at the step 460 was not the first attempt, then the employer specific encryption key for the employer was already previously-assigned and sent to the employer, and thus in such case the process can advance directly from the step 460 to the step 480. Finally, upon completion of the step 480, then at a step 490 the CAN portal session associated with employee pre-enrollment ends.

In at least some embodiments, the uploading of employee information at the step 450 includes the uploading, to the third party computer system 110, by the employer via the employer computer system 130, of a file with the following employee data elements:
(a) First Name
(b) Last Name
(c) Employee ID
(d) DOB (date of birth)
(e) Residence Zip Code
(f) Email address (optional)
(g) Mobile # (optional)
(h) Last 4 digits of SS# (TBD)
(i) Hourly Pay rate
   During the upload process, at least the employee data (d) through (i) is encrypted, using the unique encryption key assigned to each employer. Further, the employee data (a) through (c) and only encrypted data (d) through (i) is received and retained by the third party computer system 110. However, the third party computer system 110 generally does not access the employee's personal information outlined under #2 data (d) through (i).

It should be appreciated that the process of employee pre-enrollment represented by the flow chart 400 is, in at least some embodiments, limited to employers that have been approved by the third parties associated with third party computer system(s) 110 and accordingly have privileges to pre-enroll employees and otherwise interact with the CAN, as should be particularly evident from the steps 430 and 440. In granting such privileges to various employers, the third parties can take into account any of a variety of factors, and the accounting for such factors can, in at least some embodiments, be partly or entirely automated. For example, in at least some embodiments, the third parties and/or the third party computer system(s) can take into account any one or more of the following factors (which can be generally considered as regulatory, risk, and/or quantitative factors) to determine the eligibility of various employers to interact with the CAN and, by virtue of the CAN, allow for the employees of the employers to access or use the services made possible by way of the CAN (that is, allow the employers to make available the CAN program to its employees):
Employer's financial condition—going concern determination
Employer's Industry
Total number of employees
Employment status of employees: full time, part time or contractual
Employee residency state
Number of employees under a certain income range that are the ideal candidates for the program
Employee turnover ratio
Seasonality of goods and services produced and or offered
Price volatility of goods and services produced and or offered
Whether payroll is processed weekly, bi-weekly, bi-monthly, or monthly
Whether the payroll is processed internally or through third party service provider such as ADP/PayChex/Ceredian
Time management system used by the employer
Number of employees on direct deposit versus payroll checks
Number of employees working at physical locations
Other

Also, in at least some embodiments, even though a given employer is deemed eligible by the third party (or third party computer system 110), the exact features of the CAN program that are made available to that employer and its employees by the third party (or third party computer system 110) can further depend upon the information that the third party (or third party computer system 110) has received regarding that employer regarding how that employer satisfies one or more factors under consideration. That is, just because a given employer is deemed eligible for participation in the CAN program, that does not necessarily entail eligibility of the employer and its employees for all services potentially available by way of the CAN. Rather, in some embodiments or circumstances the employees of two different employers deemed eligible for participation in the CAN will be able to access and use significantly different features of the CAN depending upon the identity of their employer.

Employee Account Access

Turning to FIG. 5, an additional flow chart 500 shows example steps (or substeps) of a subprocess corresponding to the step 330 of FIG. 3, allowing for employee access to a portal made possibly by way of the third party computer system 110 and associated with the CAN, in accordance with the present embodiment. As shown, the subprocess of the flow chart 500 comments at a step 510 at which the employee visit to the CAN begins. As already indicated above, employees can access the CAN, and more particularly access accounts associated with the employees available on the CAN, in a variety of manners and by way of a variety of systems such as the employee computer system(s) 140 and/or the other user access system(s) 150. For example, depending the upon the embodiment or circumstance employee accounts can be accessed by the employees through the use of any of the following media:
1) Kiosk/Automated Teller Machine (ATM)
2) Mobile (mobile device, e.g., smart phone, cellular telephone, etc.)
3) Web (including, for example, a desktop or laptop computer having an internet browser program)
4) IVR (interactive voice response)
5) Text Messaging
   Accordingly, in FIG. 5, upon the subprocess commencing at the step 510, employee enrollment in the CAN the proceeds at a step 520, at which the employee uses the web, a mobile device, or a kiosk (or another medium or mechanism) and particularly follows (e.g., clicks on or otherwise selects) an “Enroll Me” link.

Next, as shown in a step 530, to conduct enrollment, the third party computer system 110 provides a request that the employee provide certain information corresponding to the data (a) through (c) listed above (that is, employee first name, last name, and ID) and in response the employee provides that information via the employee computer system 140 or other user access system 150 by which the employee is interfacing the CAN. Subsequently, at a step 540, upon receiving that employee information, the third party computer system 110 determines whether the first name and last name information provided concerning the employee matches corresponding information stored in the memory of the third party computer system (or otherwise in memory accessible to the third party computer system or in the CAN back end). If there is no match, then process returns from the step 540 back to the step 530, which is repeated. However, assuming that there is a match, typically because that information was already uploaded from an employer at the step 450 as described above, then, the process advances from the step 540 to a step 550.

At the step 550, several things occur. First, the employee provides data (d) through (h) listed above (that is, date of birth, residence zip code, email address, mobile device telephone number, and final four digits of social security number). Additionally at the step 550, the third party computer system 110 sends a request that the employee provide the third party computer system with consent to decrypt pre-enrollment data for employee verification and, in response, the employee provides that consent (via the employee computer system 149 or other user access system 150 by which the employee is interfacing the CAN). That is, the third party asks the employee to opt in and give electronic consent to access personal data for verification and registration—particularly, data (d) through (i) listed above that is, date of birth, residence zip code, email address, mobile device telephone number, final four digits of social security number, and hourly pay rate). It should be appreciated that, notwithstanding what is shown in FIG. 5, the granting of consent by the employee at the step 550 is optional and, if the employee declines to grant consent, then the process can be ended at the point.

However, assuming that employee consent is received at the step 550, then the process advances from the step 550 to a step 560, at which the third party software decrypts data (d) through (i) and determines whether the pre-enrollment data received from the employer at the step 450 matches the employee-provided data (d) through (h) (or (d) through (i)). If there is no match, then the process returns from the step 560 to the step 530. Alternatively, if there is a successful match, then the process advances to a step 570. At the step 570, the third party computer system 110 sends a message for receipt by the employee (by way of the employee computer system 140 or other user access system 150 by which the employee is interfacing the CAN) offering enrollment in the CAN to the employee and requesting that the employee provide consent to decrypt personal data on a permanent (ongoing) basis for future usage by the CAN. Then, as shown by a step 580, if the employee fails to give his or her consent, then the process returns to the step 530, but if the employee does give his or her consent, then the process advances to a step 590, at which the employee causes the employer computer system 140 or other user access system 150 to send a message to the third party computer system 110 specifying a username and password to allow for future accessing of the account. Also this message serves to confirm the employee's contact information. Employees can also use their mobile device telephone number (and/or an email address) as a username to access their account. Upon this message being sent (and given the successful match that occurred at the step 560), then at a step 594 the employee is enrolled in, and ready to use, the CAN. The subprocess of the flow chart 500 relating to employee enrollment is shown to then end at a step 598, at which the employee visit at the CAN for enrollment purposes ends.

Employee Wage Advances—Time Management System Integration

As discussed in regard to the step 340 of FIG. 3, when one or more employees are enrolled (or even after pre-enrollment concerning one or more employees has occurred), the third party computer system(s) 110 access and monitor employee hours data as made available by the employer computer system(s) 130 and process that data (and possibly other data as well). More particularly, in at least some embodiments, for hourly (non exempt) employees, the third party can interface with (or integrate into) the employer's time management system to determine hours employees have worked but have not been paid for. Also, for hourly employees, the third party can access (if permitted) time management data real time on each instance a wage advance is requested. Under the real time process the third party can disperse a wage advance based on earned but unpaid wages up to the time employee has worked but has not been paid. Alternatively, in at least some other embodiments, the third party can instead (or also) use a batch process to access time management data. Under the batch process, the third party can disperse a wage advance based on earned but unpaid wages up to the time employee has worked but had not been paid from the information retrieved from the batch file. A given time management batch can contain information only for a day or cumulative for a period of time. Further, for salaried (exempt) employees, the third party can assume that the employees work full time. The third party can rely on the employer to inform the third party if the employee has stopped working or has taken unpaid leave. After gaining access to employee data, the third party can store such data in a secure manner in memory associated with the third party computer system(s) or in another locations, such as in the cloud. When a transaction requires authorization by the third party, appropriate time management data is accessed from the memory or cloud versus (instead of) the employer computer system(s) 130.

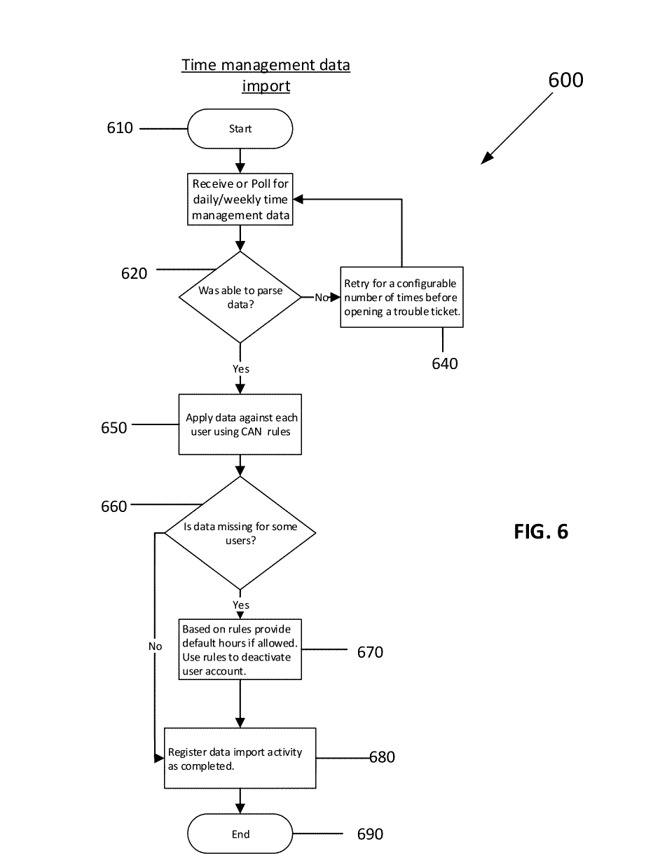

Additionally in this regard, FIG. 6 provides a further flow chart 600 that shows steps (or substeps) of a further example subprocess corresponding to the step 340 of FIG. 3 involving interactions between one of the third party computer systems 110 and one of the employer computer systems 130, by which time management data is imported by the third party computer system from the employer computer system. As shown, upon commencing at a start step 610, the process advances to a step 620, at which the third party computer system 110 receives or polls (e.g., on a daily or weekly basis or on another periodic basis) the employer computer system 130 for time management data about employees and, accordingly, such data is transmitted from the employer computer system to the third party computer system. Next, at a step 630, the third party computer system 110 determines whether the received data has been successfully parsed by the third party computer system. If not, then the process advances to a step 640, at which the third party computer system determines whether a predetermined number of failures of have occurred in terms of attempting to obtain and parse data from the employer computer system 130 and, so long as the predetermined number of failures has not yet occurred, then the process returns to the step 620 (as soon as the predetermined number of failures has occurred, then a trouble ticket is opened or an error message is sent).

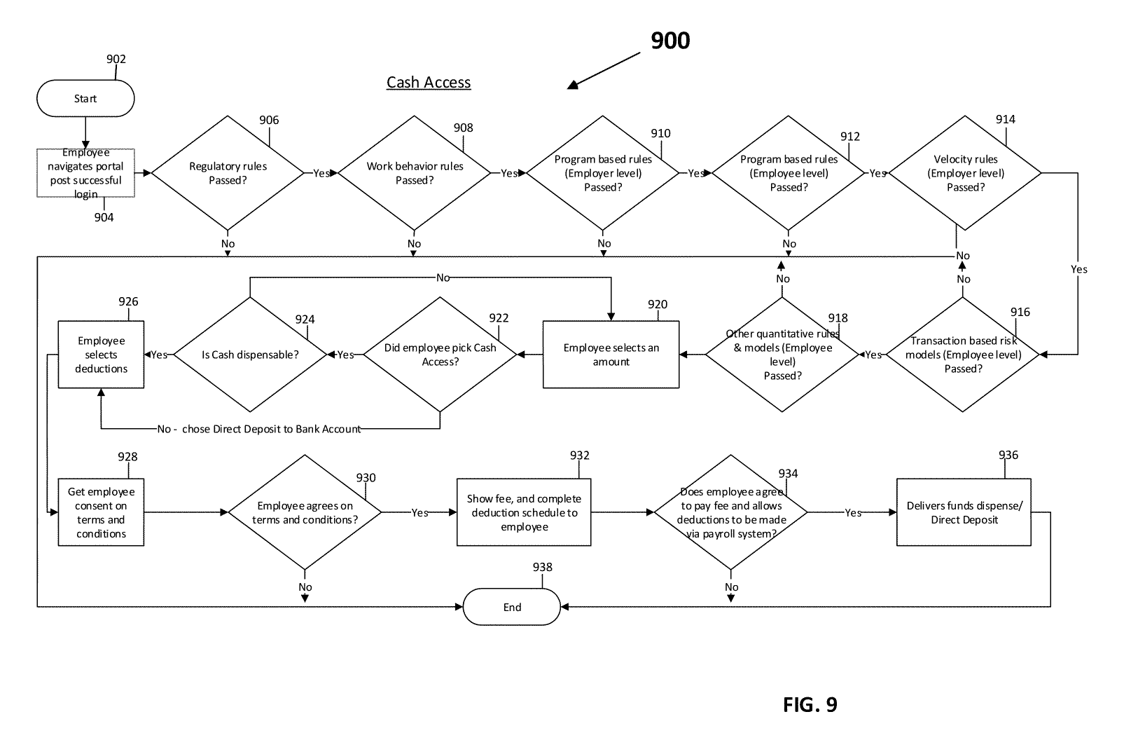

Alternatively, if at the step 630 it is determined that the received data has been successfully parsed, then instead the process advances from the step 630 to a step 650, at which the received data is applied against (in relation to) each employee (or user) using one or more rules established by the CAN, as described in more detail in relation to FIG. 9. Further, at a next step 660, the third party computer system 110 further determines whether there appears to be any data missing for one or more employees (or users). If certain data does appear to be missing in regard to one or more employees, the process advances from the step 660 to a step 670, at which the third party computer system 110 takes one or more actions as appropriate under the circumstances. For example, in some circumstances, it can be appropriate for the third party computer system 110, if allowed in accordance with one or more rules or factors (e.g., based upon assumptions regarding past employee history), to provide or allocate a default number of hours to an employee even if certain time management data regarding that employee is missing. Also for example, in some circumstances, it can be appropriate, in accordance with one or more rules or factors, to deactivate an employee's (or even an employer's) account due to the absence of certain data. Upon completion of the step 660 if no data is missing, or the step 670 if some data is missing, the process in turn proceeds to a step 680, at which the third party computer system 110 registers that the data import activity has been completed, and subsequently the process ends at an end step 690.

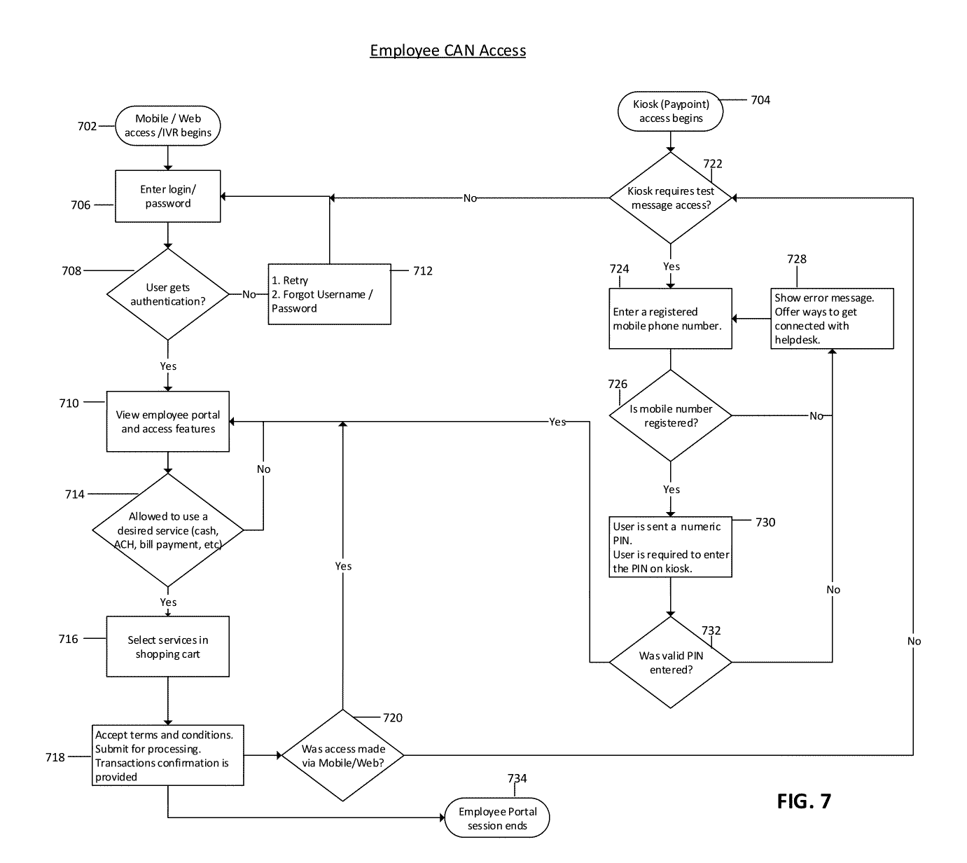

As already discussed above in relation to FIG. 3, after the pre-enrollment and enrollment of employees with the third party computer system(s) 110, and after the third party computer system(s) 110 have obtained (and stored) useful employee data in regard to one or more employees, the third party computer system(s) are ready for interacting with those employees by way of the employee computer system(s) 140 or other user access system(s) 150 in accordance with the step 350. Depending upon the embodiment, multiple types of interactions involving the access or use of one or more services made available by the third party computer system(s) 110 are possible. In at least some embodiments, these interactions include interactions by which the employees access the CAN in order to access cash (e.g., withdraw cash) based upon income that the employees have already earned due to work at their employers, but that has not yet been paid by those employers to the employees. In this regard, FIG. 7 provides a flow chart 700 showing in greater detail example steps (or substeps) of a subprocess corresponding to the step 350 of FIG. 3 in which one of the third party computer system(s) 110 interacts with either one of the employee computer systems 140 or one of the other user access systems 150.

As shown, the flow chart 700 begins either at a step 702 or at a step 704, depending the upon the type of system being used by an employee for the purpose of accessing the CAN. More particularly, if the subprocess commences at the step 702, the subprocess begins when the third party computer system 110 receives one or more communications or signals from one of the employee computer systems 140, which (as discussed above) could be for example a mobile device, another computer system allowing for web access, IVR, etc. Alternatively, if the subprocess commences at the step 704, the subprocess begins when the third party computer system 110 receives one or more communications or signals from one of the other user access systems 150, which (as discussed above) can be for example a kiosk (e.g., “paypoint”). In regard to the steps 702 and 704, it should be understood that, in some embodiments or circumstances, operation by way of a particular one of the employee computer system 140 or other user access system 150 can be mandatory or limited in some respect. For example, in some embodiments or circumstances, direct text messaging is limited to account inquiry. Also for example, in some embodiments or circumstances, a mobile phone may be mandatory for employees to be eligible for membership.

Further as shown, if the subprocess commences at the step 702 involving the employee computer system 140, then the process advances first to a step 706 at which the employee enters login (e.g., username and password) information and the third party computer system 110 receives that information. Subsequently, the third party computer system 110 determines whether the employee (user) is properly authenticated, that is, whether the login information is recognized and acceptable as an indication of an employee who was enrolled in the CAN. If so, the process advances to a step 710. Alternatively, if not, the process advances to a step 712, at which the third party computer system 110 can interact with the employer computer system in any of a number of manners by which an attempt is made to correct the login/authentication problem—e.g., by recommencing the process (“retry”) or engaging in communications with the employer computer system in a manner allowing for the possibility that the employee has forgotten his or her login information (“forgot username/password”). After the operation(s) associated with the step 710 are completed (e.g., after the employee has been provided with his or her username or password information that had previously been forgotten), the process returns to the step 706.

Alternatively, if the subprocess commences at the step 704 involving the other user access system 150 (e.g., kiosk), then the process also can reach the step 710, but in a different manner. That is, as shown, if the subprocess commences at the step 704, then the process next advances to a step 722, at which it is determined whether the kiosk requires test message access. If not, the process can proceed directly from the step 722 to the step 706, and can continue on from the step 706 as already discussed above. However, if it is determined at the step 722 that the kiosk does require test message access, then instead the process advances to a step 724, at which the third party computer system 110 further receives from the employee a registered mobile device telephone number, and further to a step 726, at which the third party computer system determines whether that received registered mobile device telephone number is in fact registered (e.g., registered with the third party computer system as a result of the enrollment process). If the telephone number is determined to not be registered, then the process advances to a step 728, at which the third party computer system 110 interacts with the kiosk in a manner causing the kiosk to show an error message to the employee, and/or causing the kiosk to offer suggestions to the employee (e.g., offering a manner of contacting a helpdesk service provided by the third party). The process then returns from the step 728 back to the step 724.

If instead, at the step 726, it is determined that the mobile device telephone number is in fact registered, then the process advances to a step 730, at which the third party computer system 110 sends a message causing the employee (user) to be provided with a four-digit numeric (or alphanumeric) PIN. The message can be provided to the employee by way of another system other than the kiosk, for example, by way of a mobile device that constitutes the employee computer system 140. In order for the employee to access the CAN via the kiosk, the employee is required to enter the PIN at the kiosk, which sends that information for receipt by the third party computer system 110. That is, the step 730 includes both the operation of sending the PIN for receipt by the employee, and the operation of receiving, back at the third party computer system 110, information that can correspond to the PIN as entered by the employee at the kiosk. Upon completion of the step 730, the process further advances to a step 732, at which the third party computer system 110 further determines whether the PIN information entered by the employee at the kiosk is valid, e.g., whether that PIN information matches the PIN originally provided by the third party computer system for receipt by the employee. If not, the process returns to the step 728 but, if so, the process again advances to the step 710 that can also be reached via the step 708 as discussed above.

In view of the above-described steps of FIG. 7, it should therefore be appreciated generally that, in at least some embodiments, kiosk based account access entails several additional steps by comparison with account access via a mobile device, other web-equipped computer, IVR, etc. Mobile, web, or IVR based account access generally require a username and password, where a username can be substituted by the employee's registered mobile phone number or email address. By contrast, for security reasons, kiosk-based account access in at least some embodiments is only possible through a cell phone based PIN (personal identification number) generation process. Therefore, below are example steps for kiosk based account access:
1) Employee arrives at the kiosk and, after initial steps (e.g., choosing a language such as English/Spanish and choosing a tab/button to log in), the kiosk screen displays a message requesting that the employee enter his or her registered mobile device phone number in the log-in screen on the kiosk, and the employee does so—in this embodiment, it is required that the employee have a mobile device (e.g., a cell phone or smart phone) with a mobile device phone number, and that the mobile device phone number be registered with the third party/third party computer system under the employee's profile.
2) If the third party computer system is able to validate the mobile device phone number that was entered at the kiosk (that is, the number entered at the kiosk matches the mobile device phone number that is registered with the third party and shown in the employee records at the third party computer system), then the third party immediately sends a unique PIN (e.g., a four-digit code) through a text message to the employee's cell phone—in this embodiment, it is mandatory that the employee have a mobile device (e.g., a cell phone or smart phone) having text capability (or at least an ability to receive the unique PIN).
3) Employee enters the PIN on the kiosk screen.
4) The third party computer attempts to validate the PIN received via the kiosk by comparing it with the PIN that was just sent to the mobile device phone number in (2) and, if the PIN received via the kiosk matches the PIN that was sent to the mobile device, then the account is successfully accessed and the employee accordingly can access the account and access his or her earned but unpaid wages (or other services).

Further in relation to FIG. 7, upon reaching the step 710, the third party computer system 110 provides web page information to either the employee computer system 140 (if the process began at the step 702) or the other user access system 150 (e.g., kiosk, if the process began at the step 704) so that an employee using one of those systems can view an employee portal and access or use one or more features of the CAN. As will be described in further detail below, a variety of services can potentially be accessed or used depending upon the embodiment, and whether a given employee is allowed to access or use any given one of the available services can depend upon various factors and/or rules. Accordingly, subsequent to the step 710 in FIG. 7, a step 714 is performed in which the third party computer system 110 determines whether the employee accessing the CAN portal is allowed to access or use a desired service (or services), such as a cash advance, ACH, bill payment, etc. If the third party computer system 110 determines that the employee is not allowed to access or use the desired service(s), then the process returns to the step 710. Alternatively, if the third party computer system 110 determines that the employee is allowed to access or use the desired service(s), then the step 714 is followed by a step 716 in which the third party computer system receives one or more signals identifying one or more employee-selected services, with the signals being provided from either the employee computer system 140 (if the process began at the step 702) or the other user access system 150 (e.g., kiosk, if the process began at the step 704). As will be described further below, in at least some embodiments, the selections of services can be specified by an employee through the use of a shopping cart feature.

Next, at a step 718, depending upon which service(s) have been selected, one or more further communications can occur between the third party computer system 110 and either the employee computer system 140 (if the process began at the step 702) or the other user access system 150 (e.g., kiosk, if the process began at the step 704). These communications can involve providing terms and conditions from the third party computer system 110 for receipt by the employee computer system 140 or other user access system 150 and receiving signals from the employee computer system or other user access system indicating the employee's acceptance of those terms and conditions. Also, these communications can involve providing transactions confirmations or other transactions-related information from the third party computer system 110 for receipt by the employee computer system 140 or other user access system 150 (and/or receiving signals from the employee computer system or other user access system relating to transactions). Also, the step 718 can involve the receipt, at the third party computer system 110, of information being submitted by an employee, as well as the processing of such submitted information or other information received at the third party computer system. Finally, depending upon the circumstance, upon completion of the step 718, the process can either continue by way of a step 720 or end at a step 734, at which the employee portal session ends. If the process continues via the step 718, the process either continues at the step 710 if the process was initiated at the step 702 by way of the employee computer system 140 or continues at the step 722 if the process was initiated at the step 704 by way of the other user access system 150.

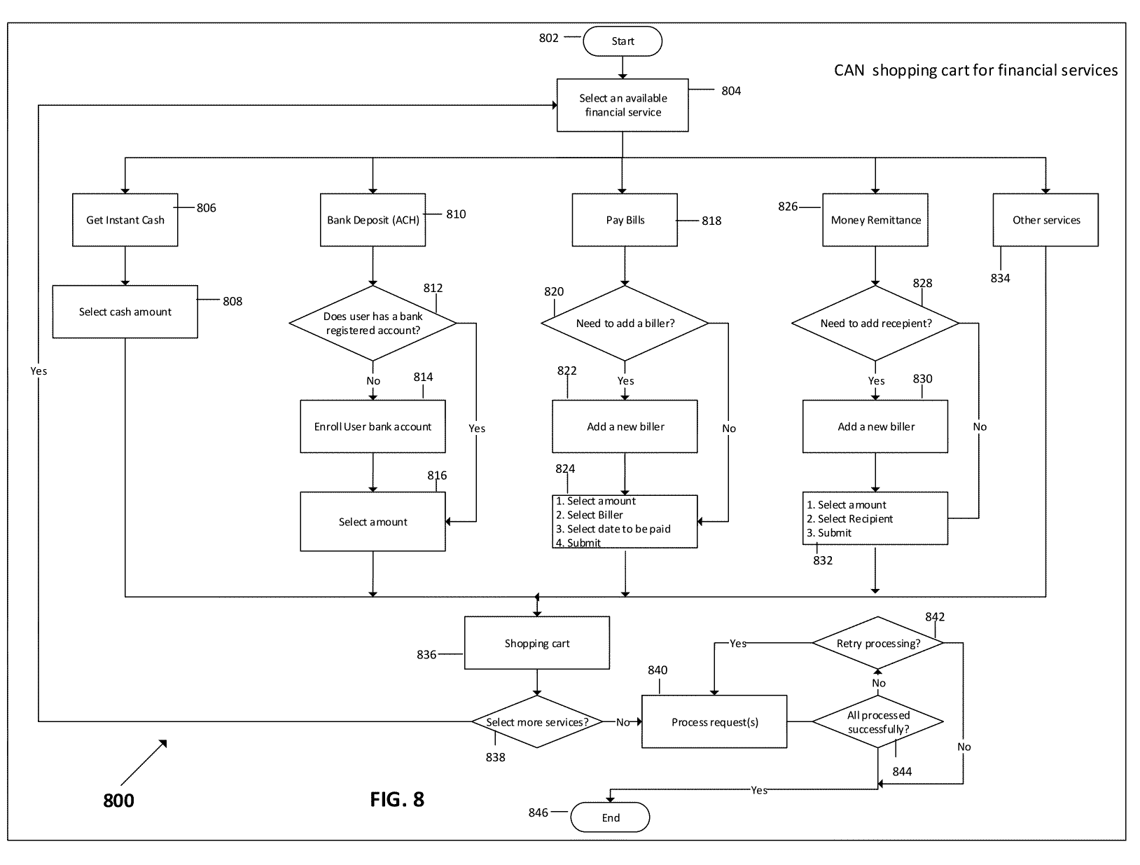

As discussed above, depending upon the embodiment, enrolled employees can access or use one or more different services made available by the CAN. FIG. 8 particularly provides a flow chart 800 illustrating an example subprocess by which several of such services can be selected, accessed, and utilized by an employee for access or use by way of an overall CAN shopping cart for financial services. The steps shown in the flow chart 800 correspond to (can be viewed as a subprocess corresponding to) several of the steps of the flow chart 700 of FIG. 7, e.g., the steps 716 and 718 of the flow chart 700. More particularly as shown in FIG. 8, upon beginning at a start step 802, the process of the flow chart 800 commences with a step 804, at which the third party computer system 110 receives a signal or an indication from an employee (user), via either one of the employee computer systems 140 or one of the other user access systems 150 (e.g., kiosk), of a selection of an available financial service from among several available financial services provided by the CAN. In the present embodiment of FIG. 8, the available services include a cash access service by which an employee can get instant cash, represented by a step 806, a bank deposit (ACH) service represented by a step 810, a pay bills service represented by a step 818, a money remittance service represented by a step 826, and one or more other services represented by a step 834. Therefore, in the present embodiment, depending upon the selection indication received at the step 804, the process can advance to any of the steps 806, 810, 818, 826, and/or 834.

In the case where the cash access service is requested, the process advances to the step 806 and then subsequently to a step 808, at which the third party computer system 110 additionally receives a signal from the employee computer system 140 or other user access system 150 indicating a selected (or requested) cash amount. After this indication is received, the process then advances to a step 836 at which this cash access request is added to a shopping cart that stores the request. Alternatively, in the case where the bank deposit (ACH) service is requested, the process advances to the step 810 and then subsequently to a step 812, at which the third party computer system 110 determines whether the employee (user) has a bank registered account. If the employee (user) does have a bank registered account, then the process advances to a step 816, at which the third party computer system 110 additionally receives a signal from the employee computer system 140 or other user access system 150 indicating a selected (or requested) deposit amount. After this indication is received, the process then advances to the step 836 at which this bank deposit request is added to the shopping cart, which stores the request. Alternatively, if the employee (user) does not have a bank registered account, then the process advances from the step 812 to a step 814, at which the third party computer system causes the employee to be enrolled in a bank account. Upon completion of the step 814, the process then again proceeds to the step 816 and ultimately the step 836.

Further alternatively, in the case where the pay bills service is requested, the process advances to the step 818 and then subsequently to a step 820, at which the third party computer system 110 determines whether there is a need to add a biller. If there is no such need, then the process advances to a step 824, at which the third party computer system 110 additionally receives one or more signals from the employee computer system 140 or other user access system 150 indicating one or more of a selected (bill pay) amount, a selected biller, a date by which the bill is to be paid, and/or a submit instruction. After this information is received, the process then advances to the step 836 at which this pay bills request is added to the shopping cart, which stores the request. Alternatively, there is a need to add a biller as determined at the step 820, then the process advances from the step 820 to a step 822, at which the third party computer system receives information allowing for the addition of a new biller and accordingly adds the new biller. Upon completion of the step 822, the process then again proceeds to the step 824 and ultimately the step 836.

Additionally alternatively, in the case where the money remittance service is requested, the process advances to the step 826 and then subsequently to a step 828, at which the third party computer system 110 determines whether there is a need to add a recipient. If there is no such need, then the process advances to a step 832, at which the third party computer system 110 additionally receives one or more signals from the employee computer system 140 or other user access system 150 indicating one or more of a selected amount, a selected recipient, and/or a submit instruction. After this information is received, the process then advances to the step 836 at which this money remittance request is added to the shopping cart, which stores the request. Alternatively, if there is a need to add a recipient, then the process advances from the step 828 to a step 830, at which the third party computer system receives information allowing for the addition of a new biller and accordingly adds the new biller. Upon completion of the step 830, the process then again proceeds to the step 832 and ultimately the step 836.

As already mentioned, in addition to the services represented by the steps 806, 810, 818, and 826, the flow chart 800 also includes the step 834 indicating that one or more other services can also be selected by an employee. Although the flow chart 800 shows the step 834 as being immediately followed by the step 836, it should be appreciated that, depending upon the particular one or more other services that are selected in relation to the step 834, the one or more additional operations associated with those one or more other services can or will be performed (e.g., operations analogous to the steps 808, 812, 814, 816, 820, 822, 824, 828, 830, and 832) and such additional operations can be considered to be part of the step 834.

Upon the process reaching the step 836 at which the most recently requested service is added to the shopping cart, then the process advances to a step 838, at which the third party computer system 110 determines whether there is an interest by the employee (user) in selecting one or more other services. This determination can be made based upon, for example, a signal received by the third party computer system from one of the employee computer systems 140 or other user access systems 150 indicating an employee interest in selecting one or more other services. If it is determined, at the step 838, that there is an interest by the employee in selecting one or more other services, then the process returns to the step 804 and then can again proceed to one of the steps 806, 810, 818, 826, and 834. It will be understood that, by virtue of such operation, more than one selected service can be added to the shopping cart and thus the shopping cart can serve to store multiple different service requests of an employee that are all made during a single portal session with the CAN.

If at the step 838, the third party computer system 110 instead determines that there is no longer any interest by the employee (user) in selecting any additional services, then instead of returning to the step 804 the process instead advances to a step 840, at which the one or more service requests in the shopping cart are processed by the third party computer system. Subsequently, at a step 844, the third party computer system 110 determines whether all requests for services have been processed successfully and if not, the process additionally advances to a step 842 at which the third party computer system determines whether processing relating to one or more of the requested services that was previously unsuccessful should be retried. If at the step 842 it is determined that such processing should be retried, then the process returns from the step 842 to the step 840 at which processing again is attempted. Alternatively, if it is determined at the step 842 that the processing should not be retried, or if at the step 844 it is determined that all requested services have been processed successfully, then the process of the flow chart 800 ends at an end step 846.

It should be understood that the processing of the various service requests corresponding to the step 840 of FIG. 8 (as well as corresponding to, in at least some embodiments, one or more of the intermediate steps 806, 808, 810, 812, 814, 816, 818, 820, 822, 824, 826, 828, 830, 832, and 834 of FIG. 8) can take a variety of forms depending upon the particular requested service. For example, with respect to the cash access service (e.g., the service corresponding to the step 806 of FIG. 8), in at least some embodiments the CAN determines whether to allow employees to access cash and, if so, how much cash those employees can access, based upon processing that takes into account many considerations and risk factors, including risk factors pertaining to specific employees as well as risk factors pertaining to the employers of those employees. The following describes in more detail the cash access service and such processing that can be performed as part of that service.

Employee Wage Advance Overview

The cash access service is a service by the third party (by way of the third party computer system(s) 110) enables employees to access wage advances that contain components of both unearned income and earned but unpaid income. Unearned income component of an advance is determined by first underwriting the employer and then on the assumption that an individual is employed and has either worked or is anticipated to work in the near future. The earned but unpaid income component of an advance is determined because employers process payroll weekly, bi-weekly, bi-monthly, or monthly for income that is already earned by an employee prior to payday. That is, most employers always (or typically) withhold wages for a certain period of time even after dispersing wages for earned income. For example, an employer that processes payroll on a bi-weekly basis and pays wages for two weeks worked at the end of third week. In this example, depending on the day under consideration, an employee can have earned but unpaid income between 1 to 21 days.

The amount of cash that can be advanced to a given employee in a given circumstance can vary depending upon the embodiment or circumstance. As described in additional detail below, the amount of unearned and unpaid and the range of up to or more than 1%-100% for earned but unpaid income is derived from applying algorithms that use definitive data about the employer and employee such as time-and-attendance, comparative analysis of historical usage patterns of the employee and other individuals, and social network data. As an example, supposing that a base advance amount of unearned income allocated to each employee is $50 and the third party determines to give employees an additional advance amount based on 50% of employee's net earned but unpaid income. Assuming 50% of net earned but unpaid income is $300, then the total amount accessible by an employee will be $350. After qualifying through risk rules, an employee will be able to access $50 (unearned income) even if there is no earned but unpaid income. In at least some embodiments, employees most always first get access to a wage advance with a guaranteed base amount calculated from unearned income regardless of whether there is any earned but unpaid income. This amount is determined by underwriting the employer and based on an active employment status (part time or full time) of an employee. Whenever an employee requests a wage advance, an amount based on unearned income is accessed first by the employee before accessing a wage advance amount based on earned but unpaid income. The employee wage advance amount may first consist of an unearned income component and then an earned but unpaid income component.

It should be understood that not only the amount of a cash advance for which an employee is eligible, but also various other terms and conditions associated with the cash advance, can vary depending upon the embodiment or circumstance. For example, with respect to term, in at least some embodiments the employee can repay the wage advance accessed all at one time through one payroll deduction or over an extended period of time (configurable) through multiple payroll deductions. The duration of the repayment term can be dependent on the payroll pay period. The payroll pay period can be weekly, bi-weekly, bi-monthly, or monthly, or in another conventional manner of conducting payroll operations or making payments to employees. Also for example, with respect to the fees charged for the cash advance service, in at least some embodiments the third party can charge a fixed fee per deduction regardless of the amount accessed by an employee. For example, a fee of $15 will be charged for a $500 wage advance with 3 deductions @ $5 per deduction. This wage advance will be repaid over 3 pay periods. Pay periods can be weekly, bi-weekly, bi-monthly, or monthly. Similarly, a fee of $5 will be charged for a $500 wage advance with 1 deduction @ $5 per deduction. This wage advance will be repaid over 1 pay period. In a preferable embodiment, the employer is not billed, and there are no upfront fees charged to either employer or employee.

Hourly Pay Rate Exception

Additionally, in at least some embodiments, the third party can apply a cap on the maximum dollar amount that an employee can obtain regardless of the percent (%) of Earned but Unpaid income accessible. For example, employees can access up to 50% of earned but unpaid net income with a maximum of $1,500. Therefore, based on the program rules, the third party may not need pay rate information for employees earning more than a certain amount-per-hour income threshold.
$1000 Limit Weekly Payroll—The third party may only need hourly rates for employees making $30 per hour or less. For Bi-Weekly Payroll, the third party may only need hourly rates for employees making $25 per hour or less.
$1500 Limit Weekly Payroll—The third party may only need hourly rates for employees making $45 per hour or less. For Bi-Weekly Payroll, the third party may only need hourly rates for employees making $35 per hour or less.

Wage Advance Transaction Authorization

As already mentioned, the processing associated with the cash advance service that is performed by the third party (by way of the third party computer system(s) 110) can take into account a variety of risk factors or “Risk Based Attributes” or other considerations in conducting that service, in determining whether to provide cash advances to one or more employees, and, if cash advances are to be provided, the amounts of the cash advances that are acceptable and/or the terms and conditions pertaining to the cash advances. Taking into account such risk factors or other considerations can be referred to as applying a “rules engine” or “risk analysis engine” to the cash advance process. In practice, processing involving application of a rules engine can be performed the third party computer system(s) 110 and/or be integrated within a cloud-based platform. Regardless of the particular computer system or systems performing such processing, application of the rules engine can involve processing that involves application of a series of configurable rules that are checked on per state, per employer, per employee, per transaction, and per interaction level, and the rules can be applied every time an employee logs in to the CAN portal (or website). Thus, an amount of a wage advance, associated repayment term and cost, and other features or characteristics of cash advances, can be impacted by rules applied through a third party's rules engine.

Among the risk factors that can be considered by the third party in implementing the cash advance process are employer-level risk controls for the third party's program, which in at least some embodiments or circumstances can include one or more of the following:
Employer's financial condition—going concern determination
Industry
Employee state of residency
Number of employees under a certain income range that are the ideal candidates for the program
Employee turnover ratio
Seasonality of goods and services produced and or offered
Price volatility of goods and services produced and or offered
Whether payroll is processed weekly, bi-weekly, bi-monthly, or monthly
Whether the employer withholds wages as a normal practice
Time management system used by the employer
Number of employees on direct deposit vs. payroll checks
Number of employees working at physical locations
Other

It should be appreciated that these types of rules can also be employed the third party (and the third party computer system(s) 110) in implementing the CAN and other features and services of the CAN more generally, and application of a rules engine taking into account these and/or other rules is not limited merely to the context of implementing the cash advance process. For example, an employer can be assigned to a program based on risk rules as part of the underwriting process. Also, it should be appreciated that, in at least some embodiments or circumstances, a single employer can have more than one program within a company for different categories of employees. Indeed, the third party (and the third party computer system(s) 110) can employ or take into account multiple different sets of rules in implementing the cash access service and/or other features or services associated with the CAN, where the different sets of rules apply to different employees that are all employed by the same employer.

Additionally, there also exist employee-level risk controls for his or her pay advance, which in at least some embodiments or circumstances can include one or more of the following:
Employee state of residency
Employee income
Employee position
Employee status
Hours worked by the employee
Days worked and or not worked consecutively vs. non-consecutively by employee
Day of the week advanced is requested by an employee in relation to work week ending for payroll processing
How frequently employee accesses the advance
A current date
An hourly rate or salary of the employee
A currency multiple dispensed at a kiosk
A number of repayments promised
How many pay periods does an employee take to repay the advance
How much of an advance employee accesses in comparison to total amount available
Acceleration of outstanding balance if employee has not worked for certain number of days within a pay period—consecutively or non-consecutively
Employee tenure factor. Percent of earned but unpaid income available to an employee is also determined by tenure of an employee with an employer. For every year of employee's employment with an employer, the third party increases the percent (configurable) of net earned and unpaid income available to an employee. For example, an employee with employment history of 2 years has 40% net earned but unpaid income available. An employee with 5 years of employment history will have 43% (5−2=3/40%+3%=43%) of net earned but unpaid income available.

Further, various additional rules can be applied by third party (and the third party computer system(s) 110) in implementing the cash access service (which rules can be applied generally with respect to or under an entire program and/or with respect to an individual employee), including for example:
Whether the state law allows employee wage advances
Amount of an advance permitted by state law
Whether the state law allows payroll deductions for repayment of wage advances
Number of maximum deductions allowed by state law
Maximum amount of deduction allowed by state law
Whether state law allows acceleration of outstanding balance
Whether state law requires spousal consent for payroll deductions
Maximum number of payments
Maximum % of net income accessible
Currency multiple dispensed at the kiosk
Maximum withdrawal amount
Minimum withdrawal amount
Maximum advance per month
Allowed number of concurrent wage advances
Minimum working hours required
Minimum employment duration in months
Minimum working days in a week
Cash access buffer days
Partial deductions (minimum %)
Deferred payment with fee or without fee
Charge deferred fee with next deduction
Non-payroll payment with fee or without fee
Charge non-payroll payment fee with next deduction
Deferred payment count restriction—configurable
Maximum number of deferred payments per advance
Transaction expiration hours
Minimum deduction amount
Access percentage In buffer Days
Skip first installment
First deduction deferral
Minimum deduction count for payment deferral
Offer subscription
Disable defer payment before days
Other
   Again, such rules can be applied not only with respect to implementation of the cash advance service but also with respect to the implementation of the CAN more generally and other services provided by the CAN.

Although the above-discussed rules are examples of rules that can be considered by the third party (and third party computer system(s) 110) in implementing the cash access service, there are numerous other rules, factors, and/or other considerations that can also be taken into account as well. Among other things, a variety of considerations can be taken into account that can result in additional types of wage advances to be provided, and/or associated limits being set. For example, in at least some embodiments, once every quarter, semi annually or annually (configurable) the third party can facilitate a wage advance with a materially larger limit. This wage advance also contains components of unearned income and earned but unpaid income. The threshold for wage advance amount based on earned but unpaid income may go up to or higher than 100% of net earned but unpaid income.

Additionally, in at least some embodiments, the third party (and third party computer system(s) 110) can take into account one or more considerations regarding possibly interplaying between the cash advance service and one or more other services provided by the CAN. For example, the amount and term permitted for a wage advance can be different (configurable) if proceeds are directly used to pay bills through the third party's billpay service versus taking cash. Also for example, the amount and term permitted for a wage advance can vary (configurable) depending on the type and amount of bill being paid through the third party's billpay service versus taking the cash. Further for example, the amount and term permitted for a wage advance can be different (configurable) if proceeds are directly used to remit funds (money transfer) through the third party's platform (billpay service) versus taking cash. Additionally for example, the amount and term permitted for a wage advance can vary (configurable) depending on the amount of remittance and the location (national versus international) where the funds are remitted through the third party's platform versus taking cash. Also for example, the amount and term permitted for a wage advance can vary (configurable) depending on who receives the remittance through the third party's platform versus taking cash. Further for example, the amount and term permitted for a wage advance can vary (configurable) depending on whether the funds remitted are sent to individuals that are members of the cash access network or not. Additionally for example, the amount and term permitted for a wage advance can be different (configurable) if proceeds are directly used to pay payroll check cashing fee for checks cashed through the third party's platform.

Further for example, the amount and term permitted for a wage advance can be different (configurable) if proceeds are directly used to pay for the type and amount of personal, business, government (municipal, state, and federal), money orders, cashier checks, demand drafts, and foreign check cashing fee for checks cashed through the third party's platform. Also for example, the amount and term permitted for a wage advance can be different (configurable) if proceeds are directly used to purchase long distance minutes through the third party's platform versus taking cash. Additionally for example, the amount and term permitted for a wage advance can be different (configurable) if proceeds are directly used to purchase and or top up prepaid cellular through the third party platform versus taking cash. Also for example, the amount and term permitted for a wage advance can be different (configurable) if proceeds are directly used to pay for goods and services from merchants where the third party has provided offers and discounts to employees. Further for example, the amount and term permitted for a wage advance can vary (configurable) depending on the type of merchant is being paid through the third party's offers and discounts versus taking cash. Types or merchant categories include brick and mortar versus ecommerce retailers or products versus services that are offered. Also for example, the amount and term permitted for a wage advance can vary (configurable) depending on the type of goods and services purchased from a merchant through the third party's offers and discounts versus taking cash.

Additionally, the amount and term permitted for a wage advance can vary (configurable) if proceeds are accessed as cash through an ATM (automated teller machine), kiosk, picked up from a retail POS (point-of-sale) integrated merchant, ACH (automated clearing house) into the employee or another person's/persons DDA (direct deposit advance) (P2P—person to person), loaded on employee's prepaid card or another person's/persons prepaid card, loaded on employee's payroll card, loaded on employee's debit card or another person's/persons debit card, loaded on employee's eWallet or another person's/persons eWallet, or loaded on employee mobile wallet or another person's/persons mobile wallet. Also, employee usage behavior and other factors can also be considered.

In view of the variety and significance of the rules, risk factors, and/or considerations as described above in providing the cash access service, FIG. 9 is additionally provided to show example steps (or substeps) of a subprocess of performing the cash access service by way of a rules engine in a manner taking into account such rules, factors, and consideration. The subprocess can generally be considered to correspond to the steps 804, 806, 808, and 840 of the flow chart 800 of FIG. 8, as will be describe in more detail below. As shown, upon commencing at a start step 902, the process of the flow chart 800 begins at a step 904 at which a given employee navigates the CAN portal (website) following successfully logging in to the portal. It can be assumed that this navigation represented by the step 904 corresponds to the steps 804 and 806 of FIG. 8, in which the third party computer system 110 receives indications from an employee (via the employee computer system 140 or other user access system 150) by which the employee selects the cash access service.

Next, subsequent to the step 904, the third party computer system 110 makes several determinations regarding whether various rules have been satisfied. In particular, the process first advances from the step 904 to a step 906, at which it is determined whether regulatory rules have been passed. If so, the process advances from the step 906 to a step 908, at which it is determined whether behavior rules have been passed. If so, the process advances from the step 908 to a step 910, at which it is determined whether program based rules, which are employer level rules, have been passed. If so, the process advances from the step 910 to a step 912, at which it is determined whether program based rules, which are employee level rules, have been passed. If so, the process advances from the step 912 to a step 914, at which it is determined whether velocity rules, which are employer level rules, have been passed. If so, the process advances from the step 914 to a step 916, at which it is determined whether transaction based risk models, which are employee level rules (or models) have been passed. If so, the process advances from the step 916 to a step 918, at which it is determined whether other quantitative rules and modes, which are employee level rules or models, have been passed. If so, the process advances from the step 918 to a step 920. As shown, the process only advances down the line of successive steps 906, 908, 910, 912, 914, 916, and 918, so as to arrive at the step 920, if the rules (or factors, conditions, or models) associated with all of those steps are satisfied. If the third party computer system 110 determines that the rules associated with any of the steps 906, 908, 910, 912, 914, 916, and 918 are not satisfied, then the process advances to an end step 938.

Upon reaching the step 920 when it is determined that all of the rules considered during the steps 906, 908, 910, 912, 914, 916, and 918 have been satisfied, the third party computer system 110 at the step 920 receives an indication from the employee (provided by way of the employee computer system 140 or other user access system 150) of a selected cash advance amount. The performing of this step 920 corresponds to the performing of the step 808 of FIG. 8. Further, upon completion of the step 920, the process then can advance to successive steps 922, 924, 926, 928, 930, 932, 934, and 936 before ultimately concluding at the step 938, where each of the steps 922, 924, 926, 928, 930, 932, 934, and 936 generally relate to processing and service request fulfillment performed or controlled (at least indirectly) by the third party computer system 110, and where each of the steps can be generally considered as corresponding to the step 840 of FIG. 8. As will be appreciated, one or more of these steps can involve operations that relate the performing of the cash advance service to one or more other services available from the CAN.

More particularly in this regard, upon completion of the step 920, the process next advances to a step 922, at which it is determined whether the employee selected the cash access service (e.g., whether a request for that service is stored in the shopping cart). If so, the process then advances to the step 924, at which the third party computer system 110 determines whether the employee-selected cash advance amount is dispensable. Whether the cash advance amount is dispensable can be determined by the third party computer system 110 based upon the particular conclusions reached during application of the rules engine (including for example the particular conclusions reached during the performing of any of the steps 906, 908, 910, 912, 914, 916, and 918) and/or based upon other factors, such as an availability of cash for dispensation at a kiosk or other user access system at which cash is to be disbursed. In one example embodiment, the risk analysis takes into account one or more of a current date, an hourly rate or salary of the employee, a currency multiple dispensed at a kiosk, and/or a number of repayments promised. In at least some embodiments or circumstances, a risk determination can be made even where the third party (or third party computer system 110) does not have immediate access to information such as the number of hours the employee requesting the cash advanced has worked (or the number of hours worked recently).

If it is determined that the cash is not dispensable, then the process returns to the step 920, at which the employee is given an opportunity to select (request) a different amount of cash to be advanced. Alternatively, if it is determined at the step 924 that the selected cash amount is dispensable, and also if it is determined at the step 922 that the employee did not select the cash advance service, then in each case the process instead advances from the step 924 to the step 926. Upon reaching the step 926, the third computer system 110 further receives an indication from the employee (provided via the employee computer system 130 or other user access terminals 150) regarding selections as to the manner in which deductions are to be made, that is, selections as to the manner in which any cash that is advanced to the employee will be repaid by the employee, e.g., deductions with respect to future paychecks, etc. Then, upon completion of the step 926, the process advances to the step 928 at which the third computer system 110 intercommunicates with the employee (again via the employee's operation of the employee computer system 130 or other user access system 150) so as to request that the employee consent to terms and conditions pertaining to the cash advance. Then, at the step 930, the third party computer system 110 determines whether a signal provided by the employee (via the employee computer system 130 or other user access system 150) indicates that the employee agrees to the terms and conditions pertaining to the cash advance. If not, the process ends at the step 938 and no cash advance is made.

However, if the employee does agree to the terms and conditions, the process next advances from the step 930 to the step 932, at which the third party computer system 110 provides a signal to the employee computer system 140 or other user access system 150 being utilized by the employee that causes that employee computer system or other user access system to display for the employee (or otherwise communicate to the employee) the fee(s) to be charged for the cash advance, as well as a complete deduction schedule. Next, at the step 934, the third party computer system 110 determines whether a signal provided by the employee (via the employee computer system 130 or other user access system 150) indicates that the employee agrees to the fee(s) to be charged for the cash advance and the deduction schedule, e.g., the deductions to be made via the payroll system to allow for repayment of the cash advance. If the employee is unwilling to agree to the fee(s) or deduction schedule, then the process ends at the step 938 and no cash advance is made. However, assuming that the employee does agree to the fee(s) and deduction schedule, then the process advances to the step 936, at which the requested cash advance is provided by the third party, for example by way of the delivery or dispensation of funds by way of the other user access system (kiosk) or by way of direct deposit, and then the process also ends at the step 938. It should recognized that, in at least some embodiments, when cash advances are provided at the step 936, the third party computer system 110 also at that step interacts with the employer computer system(s) of the employers of the employees to whom the cash advances are being provided, so that the employer records reflect these transactions. Such interactions can be considered as being encompassed by the step 360 of FIG. 3.

Employee Wage Advances—Settlement Options

Further in regard to the step 936, it should be appreciated that the third party can provide multiple options for employees to access funds associated with wage advances. Among other things, these can include any one or more of the following:
Cash at kiosk
ACH into DDA (Direct Deposit Advance)
Wire (Wire Transfer)
Debit Card Load
Prepaid Card Load
eWallets
Mobile wallets
POS (Point-of-Sale) pick-up (e.g., at a retail store such as Safeway/Kroger/etc. . . . )
Other

Employee Wage Advances—Repayment/Collections

As noted above in relation to FIG. 9, in at least some embodiments, an employee requesting a cash advance can select from among various different options in terms of repayment. Repayment of the wage advance is primarily through payroll deductions from employee's net pay. An amount of the wage advance and the associated repayment deductions may (in at least some circumstances) have no correlation with the calculation and payment of employee wages. Repayment is primarily obtained from employee's net pay which is calculated by deducting taxes and all other statutory deductions from gross pay. Under rare circumstances employees may exercise an option to repay the advance directly to the third party as an alternative to payroll deductions. In some embodiments, employees can also repay the wage advance through ACH, credit card or debit card in one or multiple payments. Also, in at least some embodiments, employees can accelerate repayment term without penalty, and/or employees can also request to skip payment.

The following are example steps by which the repayments are processed by the overall financial transactions system 100, particularly by way of the third party computer system(s) 110 and interactions between those system(s) and other system(s) such as the employer computer system(s) 130.
1) A deduction file is generated by the third party based upon the advance amount due and associated fees.
2) The deduction file is sent to the employer by the third party based upon employer payroll processing frequency and associated deadlines via FTP, web service, email, or other file transfer mechanisms.
3) Payroll Deduction
   Employer can manually deduct from employee's payroll through data entry.
   Employer can import the deduction file into payroll system.
   The third party can integrate into the payroll system and upload the file for the employer.
4) Employer's payroll processor deducts and pays the deducted amount to the third party by check or ACH.
5) If the employer processes payroll internally then payment is made directly by the employer to the third party by check of through ACH
   It should be appreciated that such steps related to the repayment of cash advances can be generally considered as being encompassed by the step 360 of FIG. 3, according to which the third party computer system(s) 110 interact with the employer computer system(s) 140 so that the records at the employer computer system(s) reflect employee accessing/usage of the CAN services.

It should be appreciated that the exact configurations and features of the website and web pages associated with the CAN portal that are provided by the third party computer system(s) 110 and accessed by systems such as the employer computer system(s) 130, employee computer system(s) 140, and other user access system(s) 150 can vary depending upon the embodiment. In at least some embodiments, the website and web pages are configured so as to be suitable for display and to facilitate interactivity on different types of computer systems, such as desktop computers or mobile devices. Further, in at least some embodiments, the configurations and features can vary in dependence upon the type of client system that is interacting with the third party (server) computer system(s). For example, in some such embodiments, the web pages of the website take one form when accessed by a client that is in the form of a desktop computer, and the web pages of the website take a second form when accessed by a client that is in the form of a mobile device. Thus, depending upon the embodiment or operational circumstance, the graphical user interface (GUI) by which a user (e.g., an employee or an employer administrator) interacts with the overall financial transactions system 100 can vary considerably. More particularly, the GUI provided at one of the employee computer system(s) 140 or other user access system(s) 150 by which an employee interacts with the CAN as provided by the third party computer system(s) 110 can vary depending the upon the particular employee computer system or other user access system that is being utilized.

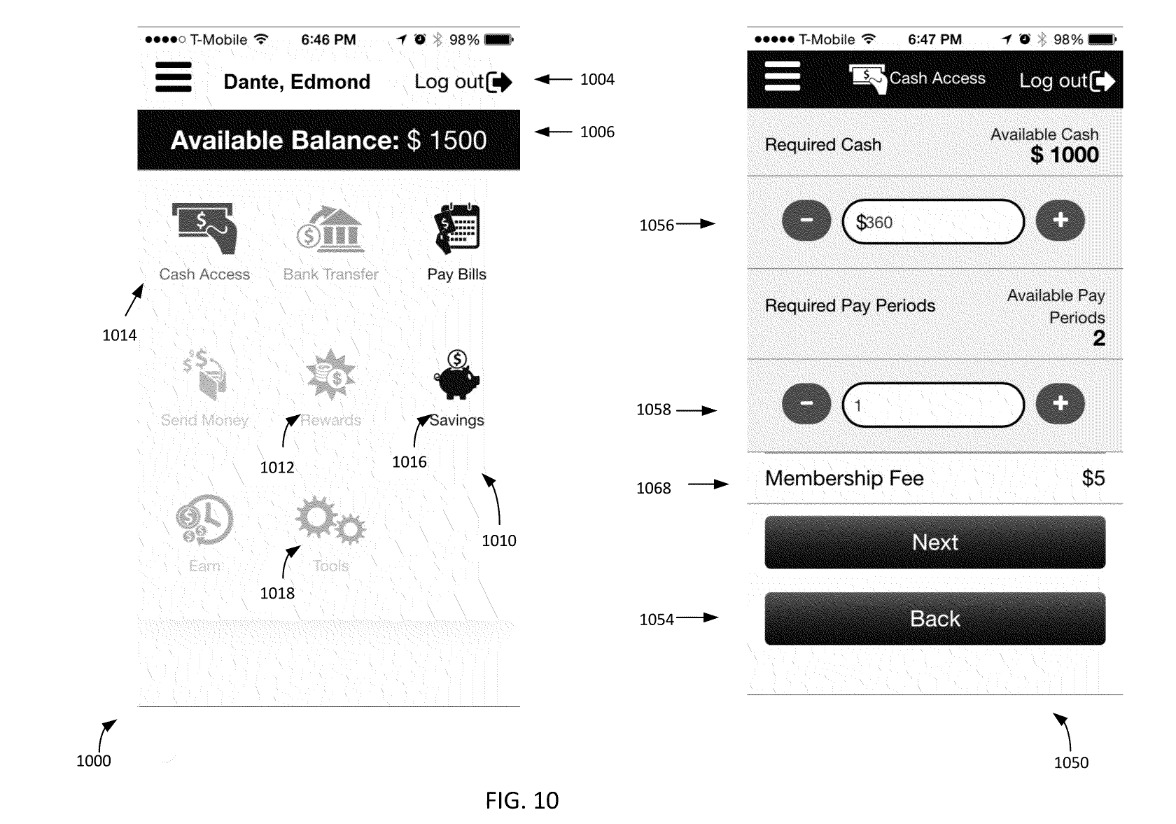

Further in this regard, FIG. 10 illustrates example first and second screen shots 1000 and 1050 that can be provided on a smart phone serving as one of the employee computer system(s) 140 when an employee is interacting via that smart phone with the third party computer system(s) 110 providing the CAN. In these example screen short, the first screen shot 1000 is an example of an initial (or “Step 1”) GUI that appears when an employee first logs in to the CAN, e.g., at a time corresponding to the step 710 of FIG. 7. As shown, the first screen shot 1000 among other things shows a name bar 1004 listing the employee who has logged into the account, an available balance bar 1006 listing the amount of money that the employee can access (or that the employee has available in an associated account). Additionally, the first screen shot 1000 also includes a selection region 1010 having first, second, third, and fourth buttons 1012, 1014, 1016, and 1018, respectively. The first button 1012 is a rewards button that, if pressed, allows the employee to apply for rewards or view what rewards have already been ascribed to the employee. The third button 1016 is a Savings button that, if pressed, allows the employee to perform savings transactions occurring via the CAN that relate to that employee. The fourth button 1018 is a Tools button that, if pressed, affords the employee with one or more options to analyze metrics or data relating to that employee.

As for the second button 1014, this is a cash access button that, if pressed, causes the smart phone to send a signal to the third party computer system(s) 110 indicating selection of the cash access service in accordance with the steps 804 and 806 of FIG. 8, and which in turn results in the second screen shot 1050 appearing on the smart phone. As can be seen, the second screen shot 1050 has a back button 1054 that, when pressed, causes the screen to revert to the first screen shot 1000.

In addition, there appears a first region 1056 and a second region 1058. The first region 1056 is a region allowing the employee to enter/specify a desired cash amount (e.g., $360 as shown), in accordance with the step 808 of FIG. 8 and the step 920 of FIG. 9. By comparison, the second region 1058 is a region allowing the employee to enter/specify a desired deduction schedule (e.g., a single deduction as shown). Finally, also as shown, the second screen shot 1050 also includes an additional summary bar 1068 which summarizes the membership fee (or other fee information).

As discussed above and shown particularly in FIG. 8, in at least some embodiments, the cash advance service is only one of multiple services that are made available by the overall financial transactions system 100 forming the CAN and that can be selected by an employee (or other user) and placed in a shopping cart of requested services. Although FIG. 8 shows an example process for accessing multiple different services and utilizing an online shopping cart to access applicable product(s) and service(s) through an online environment (or product), it should be emphasized that the particular services discussed in relation to FIG. 8 are only some examples of services that can be provided via the CAN. Also, it should be appreciated that, in at least some embodiments or circumstances, the performing of one or more requested services can relate to or involve one or more of the other services. For example, in at least some embodiments or circumstances, proceeds from a wage advance can either be accessed in full or instead be accessed partially, with a portion of the proceeds instead being allocated to other products and services with or without fees (with such aspects being configurable).

That said, in at least some further embodiments, in addition to the cash advance service, the CAN is able to provide any or all of the following services:
Loyalty
Savings
Bill Pay
Check cashing
Money Remittance
Long Distance minutes
Prepaid Cellular Top-Up
Other
   Additional details regarding several of these example services are provided below.

Loyalty

In at least some embodiments, a proprietary loyalty program can be used that assigns a value (configurable) to each transaction conducted through the third party platform by its members. Loyalty value can be redeemed towards the cost of financial transaction accessed through the third party's platform or redeemed for value through:
Kiosk/ATM
ACH into DDA
Loaded on GPR prepaid card
Loaded on debit card
Loaded on eWallet/Mobile wallet
POS pick-up
Deposited into a savings account
Other
   Additionally, the third party can impose a minimum limit for redemption for value because of the cost associated with processing a transaction and limitations associated with kiosk cash denomination disbursements.

Savings

In at least some embodiments, the third party can provide members with a financial institution-issued savings account if a member does not have one. This method of savings allows employees to save irrespective of whether they have a DDA (direct deposit account) with or without direct deposit. In at least some such embodiments:
Employees may have the option to allocate a value towards their savings account from their net pay through the third party's platform. The third party can capitalize on the payroll integration that already exists with the employer to facilitate deductions for employee wage advances. Employees can choose the amount and frequency of deduction towards their savings account from their account. The third party can process the deduction and settle the amount into employee's savings account. This method of savings does not allow the employee to receive their pay and then make a determination to save. Savings are a deduction directly from employee's net pay and deposited directly into employee's savings account.
Employers can use third parties' systems to incentivize employees by depositing funds directly into employees' savings accounts.
The third party can structure the wage advance repayments with additional deduction (configurable) option to facilitate savings. Amounts from the additional deductions are deposited into employee's savings account. For example if an employee takes an advance for $300 with 2 deductions. Total amount outstanding will be $310 ($300 in principal+$10 in fees) with 2 deductions for $155 each. To encourage savings, the third party can provide employees the option for additional deductions (configurable) and an amount of employee choosing (configurable). Any amount deducted over $310 will be deposited into employee's savings account by the third party.
The third party can deposit the redeemable value of loyalty earned by its members into their savings account. The third party can match and increase the loyalty generated value (configurable) if deposited into a savings account.
The third party can pay a higher interest rate than market (configurable) for amounts deposited into savings account.

Bill Pay

In at least some embodiments, the third party can provide its member (e.g., an employee) with the ability to pay bills online through a platform. In at least some such embodiments:
A billpay service can be accessed through member's account from mobile, web, or kiosk.
The third party can offer both regular and expedited billpay options.
The third party may not charge for a certain number of billpay transactions (expedited bill pay not applicable) per wage advance if proceeds from wage advance are used towards a billpay transaction.
The third party has the option to accept credit/debit/ACH form of payment to pay for billpay transactions

Check Cashing

In at least some embodiments, the third party can cash payroll checks for its members by way of the other user access system(s) 150 such as a kiosk. This manner of operation can alleviate the need to disperse multiple currency denominations and or coins for the exact amount of check proceeds. In at least some such embodiments:
The third party can install a check scanner on its kiosk to capture an image of the check presented by its members.
The third party then parses the data elements from the check image and cross references the data elements with the Positive Pay File the employer shares with third party for the issued checks.
If data elements are positively match, the third party then verifies if there are available funds in the kiosk to cash the check.
If sufficient funds are available, the third party then voids the check and disperses the cash.
If the third party's kiosk can disperse the exact the amount of the check value then the transaction is complete. The third party then proceeds to settle the check through the check clearing process. For example, the kiosk will disperse ten $20 notes if the check was for $200.
In another example the check was for $230 and the kiosk only contained $20 currency notes. Under this instance, the third party will disperse $240, and the member—if approved—will get a $10 wage advance for the difference. Due to the regulations associated with check cashing disbursements, the third party may not under disperse from the kiosk. If needed and approved, the third party will over disperse with the difference allocated towards a Wage Advance deducted from member's next pay period.

Notwithstanding the above description, it should additionally be recognized that the present disclosure should not be viewed as being limited to the concepts described above or shown in FIGS. 1-10, but rather that the present disclosure is intended to encompass numerous other system features and processes of operation above and beyond those described above, as well as combinations of the concepts described above with such other system features and processes of operation. For example, in at least some embodiments, other features such as a “Peer To Peer Lending” service can be made available to members/employees. In at least some such embodiments, when an employee becomes a member of a program at an individual employer level and participates through CAN, other members within an individual employer or under the global program (e.g., aggregate of employers) are able to participate in financing the needs of an individual member thru peer-to-peer lending function offered by the third party under CAN. Employees can fund other employee wage advances through the CAN network. Employees providing funds can earn interest on funds invested. Alternatively, if employees funding wage advances choose to not accept interest, a fee discount can be passed to employees in need of wage advances. Enrolled members within an employer also can assist other known or unknown, enrolled or non-enrolled members by guaranteeing repayment for employee wage advances. The guarantor employee (member of CAN) can satisfy the obligation if repayment through payroll deduction from an employee receiving funds is not successful.

Further, in at least some additional embodiments, a member/employee can select a recurring payments option (particularly in regard to the disbursement phase). In such embodiments, an employee can opt for a recurring wage advance under one contract with allocation of funds for transactions like billpay, remittance, and P2P as examples. Also, in at least some other embodiments, a member/employee can select an anticipatory payment option. With employee opt in and biller account access, the third party using data based predictive analytics can proactively pay bills, top up cellular prepaid, and offer other services from wage employee advances.

Therefore, although the present disclosure describes particular embodiments of systems and methods, it should be understood that the present disclosure is not intended to be limited to the specific concepts or features described above. Rather, the methods, systems, and devices discussed above are intended merely to be examples. Further, it should be appreciated that the various embodiments encompassed herein can omit, substitute, or add various procedures or components as appropriate relative to the particular embodiments described above. For example, it should be appreciated that the methods described above (e.g., in the flow charts of FIGS. 3, 4, 5, 6, 7, 8, and 9) instead in alternate embodiments can be performed in orders different from those described above, and/or that various steps can be added, omitted, or combined. Indeed, the steps or operations described herein can be performed in the sequences given above or in different orders (with the orders of the steps rearranged) as applicable. Further, although some of the processes described above involve operations performed as a sequential process, in other embodiments many of the operations can be performed in parallel or concurrently. Also, a number of steps can be undertaken before, during, or after the above-described process steps are performed. The processes (including subprocesses) and process steps (or substeps) encompassed by the present disclosure can be implemented in any of a variety of manners, can be automated in any of a variety of computers or other machines, and can be coded in software, firmware, or hard coded as machine-readable instructions and/or run through one or more processors that can implement the instructions.

Also, features described herein with respect to certain embodiments can be combined in various other embodiments, and different aspects and elements of the embodiments can be combined in a similar manner. Indeed, various features and aspects of the above-described concepts can be used individually or jointly. Additionally, although certain specific details are given in the description to provide a thorough understanding of the embodiments, it should be understood that the present disclosure also encompasses embodiments that can be practiced without these specific details. The specification and drawings are, accordingly, to be regarded as illustrative rather than restrictive. Further, it should be appreciated that the described systems, components, and devices can merely be components of still larger systems, where other rules can take precedence over or otherwise modify the operations or manners of application described above. Further, it should be appreciated that the concepts encompassed by the present disclosure can be utilized in any number of environments and applications beyond those described herein without departing from the broader spirit and scope of the specification. Additionally, it should be emphasized that technology evolves and, thus, many of the elements are examples and should not be interpreted to limit the scope of the invention.

Therefore, having described several embodiments, it will be recognized by those of skill in the art that various modifications, alternative constructions, and equivalents may be used without departing from the spirit of the invention. It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A method of providing one or more financial services to an employee of an employer by way of an intermediary, the one or more financial services at least including a cash advance service configured to facilitate payments of accrued and unpaid earnings before an end of a current pay period, the method comprising:
causing a code to be sent from an intermediary computer system for receipt by a mobile device associated with the employee;
receiving, at the intermediary computer system, a signal indicating an entering of the code at a user access terminal being operated by the employee, wherein the intermediary computer system is configured to consider the employee to have successfully logged in based at least in part upon the received signal;
receiving, at an intermediary computer system a first indication of a selection of the cash advance service;
receiving, at the intermediary computer system, a second indication of a desired cash advance amount;
determining a risk associated with a payment of the desired cash advance amount and, based at least upon the determined risk, that either the desired cash advance amount or an alternate cash advance amount can be paid, wherein the risk is determined at least in part by way of an application of a rules engine that takes into account one or more risk factors including at least one risk factor associated with the employee; and
causing, at least indirectly, either the desired cash advance amount or the alternate cash advance amount to be paid to the employee.

2. The method of claim 1, wherein the user access terminal being operated by the employee is a kiosk and a phone number associated with the mobile device is stored in a memory location of or accessible to the intermediary computer system, wherein the phone number is utilized to allow the code to be sent for receipt by the mobile device.

3. The method of claim 2, wherein the one or more financial services additionally includes one or more of a bank deposit service, a pay bills service, and a money remittance service.

4. The method of claim 3 wherein, prior to the causing, the intermediary computer system receives pre-enrollment information from an employer computer system allowing for pre-enrollment of the employee.

5. The method of claim 4 wherein, prior to the causing but after the receiving of the pre-enrollment information, the intermediary computer system receives at least some additional information regarding the employee from either an employer computer system or the user access terminal or an alternate user access system being operated by the employee, and further receives an employee consent to a decryption of at least some of the pre-enrollment information pertaining to the employee.

6. The method of claim 4, further comprising receiving additional information from the employer computer system concerning recorded working hours of the employee.

7. The method of claim 3, wherein requests for each of the one or more financial services can be stored in a shopping cart location.

8. A system for performing the method of claim 1, the system comprising the intermediary computer system.

9. The system of claim 8, wherein the system further includes the user access terminal, an employer computer system, and an employee computer system.

10. The system of claim 9, wherein the employer computer system includes, or is configured to operate as each of, a payroll system, a time management system, and an administrative portal.

11. A method of facilitating payment to employees of accrued and unpaid earnings before an end of a current pay period, the method comprising:
receiving a request from an employee for a payment;
estimating a current accrued and unpaid earnings for the employee, the estimating based upon an hourly rate of the employee, the estimating occurring without access to actual hours that the employee has worked;
calculating a risk of repayment based at least in part on the estimating;
transferring payment to the employee based on the risk being within a threshold;
determining a number of repayments; and
deducting a fixed fee for each of the repayments.

12. The method in claim 11, further comprising pre-enrolling the employee by storing encrypted employee personal data in a memory unit.

13. The method in claim 12, further comprising enrolling the employee by obtaining employee consent to decrypt the encrypted employee personal data for employee verification.

14. The method in claim 11, where the payment is transferred as one selected from cash, billpay, remittance, savings, and shopping service.

15. The method in claim 11, further comprising obtaining a repayment of the transferred payment through payroll deductions from the employee's net pay during a subsequent pay period.

16. A system for determining a risk of default in regard to payments to employees of accrued and unpaid earnings before an end of a current pay period, the system comprising:
a computer processor; and
a memory operatively coupled with the computer processor, the computer processor executing operations in accordance with software instructions stored in the memory;
a payment distribution device operatively connected with the computer processor;
an input device configured to receive a request for a payment of accrued and unpaid earnings from an employee of an employer; and
a risk analysis engine configured to determine a risk of nonpayment by an employee, the determination based on at least one of:
a current date;
an hourly rate or salary of the employee;
a currency multiple dispensed at a kiosk; and
a number of repayments promised;
wherein the computer processor commands the payment distribution device based on the risk determined by the risk analysis engine.

17. The system of claim 16, wherein the payment distribution device is a kiosk.

18. The system of claim 16, wherein the payment distribution device is an automated teller machine (ATM).

19. The system of claim 16, wherein the input device configured to receive a request for a payment of accrued and unpaid earnings from an employee of an employer is one of a kiosk, mobile device, web browser and interactive voice response (IVR) system.

20. The system of claim 19, further comprising wherein the computer processor interacts with an employer computer system so that records of the employer computer system reflect employee use of the service of obtaining the payment of accrued and unpaid earnings from an employee of an employer.
